(19) United States
(12) Patent Application Publication
(10) Pub. No.: US 2015/0381849 A1
(43) Pub. Date: Dec. 31, 2015

(54) Document Processing Device That Facilitates Evaluation of Document, Document Processing Method, and Recording Medium

(71) Applicant: Kyocera Document Solutions Inc., Osaka (JP)

(72) Inventor: Toru Yasui, Osaka (JP)

(21) Appl. No.: 14/751,155

(22) Filed: Jun. 26, 2015

(30) Foreign Application Priority Data
Jun. 26, 2014 (JP) 2014-130954
Jun. 26, 2014 (JP) 2014-130957

(51) Int. Cl. H04N 1/23; G06F 17/30; H04N 1/00; G06F 3/12; H04N 1/21

(52) U.S. Cl. CPC H04N 1/2315; G06F 3/1204; G06F 3/1206; G06F 3/1267; G06F 3/1297; H04N 1/2166; H04N 1/00114; H04N 1/00204; G06F 17/30011; G06F 17/301; H04N 2201/0094

(57) ABSTRACT

A document processing device includes a storage circuit, an input circuit, an output circuit, and a control circuit. The storage circuit stores document data including at least one of character data and image data. The output circuit outputs the stored document data. The control circuit causes the output circuit to output the stored document data to evaluate the document data by at least one evaluator. The input circuit accepts location information and an evaluation result. The location information indicates a location of at least one evaluated part selected by the at least one evaluator who has evaluated the output document in the document data. The evaluation result is given to each of the evaluated parts. The storage circuit stores the location information and the evaluation result accepted by the input circuit. The control circuit extracts the evaluated part from the document data based on the stored location information.

### INCORPORATION BY REFERENCE

This application is based upon, and claims the benefit of priority from, corresponding Japanese Patent Application Nos. 2014-130954 and 2014-130957 each filed in the Japan Patent Office on Jun. 26, 2014, the entire contents of which are incorporated herein by reference.

### BACKGROUND

Unless otherwise indicated herein, the description in this section is not prior art to the claims in this application and is not admitted to be prior art by inclusion in this section.

Recently, in association with an increase in a count of documents to be handled, a mechanism for efficient management of registered documents has been desired in an information appliance, such as a server and an image forming apparatus (for example, a multifunction peripheral), which register and manage the documents. Accordingly, the following mechanisms have been developed.

For example, a typical technique first reads from a memory card documents to be registered with an image forming apparatus and metadata of the documents. Then, the technique converts the documents and the metadata into a document format handled by the image forming apparatus to accumulate the documents and the metadata. Then, the technique collates keywords input by a user and keywords registered with the metadata to search the registered documents.

Another typical technique variously analyzes a composition to be analyzed using a keyword used for search, a phrase representing an evaluation to the keyword, and an evaluation value totalized when the phrase appears in a sentence. The technique searches the keyword in the composition, and extracts the phrase representing the evaluation around the found keyword. Depending on the content of the phrase, an evaluation to an author on the searched keyword is acquired. Then, the technique totalizes the acquired many evaluations for analysis.

To distribute an advertisement on a Web page, yet another typical technique evaluates words in the Web page to determine an opinion to a product from the evaluation by words. Based on the determined opinion, the technique creates an extracted summary or a descriptive summary and inputs the summary to a template. Thus, the technique forms an advertisement to the product.

While a user browses a certain document (browsing document), yet another typical technique searches another document using a word in the document or a similar character as a keyword. Among the documents listed as a search result, the document referred by the user is set as a reference document. The technique accumulates the relationship between the browsing document and the reference document as metadata for various analyses.

### SUMMARY

A document processing device according to an aspect of the disclosure includes a storage circuit, an input circuit, an output circuit, and a control circuit. The storage circuit stores document data including at least one of character data and image data. The output circuit outputs the stored document data. The control circuit causes the output circuit to output the stored document data to evaluate the document data by at least one evaluator. The input circuit accepts location information and an evaluation result. The location information indicates a location of at least one evaluated part selected by the at least one evaluator who has evaluated the output document in the document data. The evaluation result is given to each of the evaluated parts. The control circuit further causes the storage circuit to store the location information and the evaluation result accepted by the input circuit. The control circuit extracts the evaluated part from the document data based on the stored location information.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a concrete example of a usage environment when achieving a document processing device according to a first embodiment of the disclosure using a general computer as a document processing server.

FIG. 2 illustrates a configuration of the document processing server used as the document processing device according to first embodiment.

FIG. 3 illustrates a configuration of concrete example of a usage environment when achieving the document processing device according to the first embodiment as an image forming apparatus.

FIG. 4 illustrates the configuration of the image forming apparatus used as the document processing device according to the first embodiment.

FIG. 5 illustrates a concrete example of a state where an evaluator gives a Like attribute to a specific part specified by the evaluator in a registered document with the document processing server or the image forming apparatus according to the first embodiment.

FIG. 6 illustrates a concrete example of metadata generated using a structured language format, such as an XML, according to the first embodiment.

FIG. 7 illustrates steps of processing at the first phase of registering a document to be evaluated with the image forming apparatus according to the first embodiment.

FIG. 8 illustrates steps of processing at the second phase of evaluating the document registered with the image forming apparatus according to the first embodiment.

FIG. 9 illustrates a concrete example of processing where two evaluators (evaluator A and evaluator B) evaluate a document with the image forming apparatus according to the first embodiment.

FIG. 10 illustrates a concrete example where a user who registers the document as the first phase also in charge of an evaluator for the second phase and collectively processes the first phase and the second phase.

FIG. 11 illustrates steps of processing at the third phase where image data included in a document is shared based on metadata regarding collected evaluations.

FIG. 12 illustrates a concrete example of collectively processing the second phase and the third phase.

FIG. 13 illustrates exemplary utilization of the shared image data performed after sharing the image data in the third phase.

FIG. 14 illustrates the configuration of the document processing server used as the document processing device according to a second embodiment of the disclosure.

FIG. 15 illustrates a configuration of an image forming apparatus used as a document processing device according to the second embodiment.

FIG. 16 illustrates a concrete example of a state where an evaluator gives a Like attribute or a Dislike attribute to a specific part specified by the evaluator in a registered document with the document processing server or the image forming apparatus according to the second embodiment.

FIG. 17 illustrates a concrete example of metadata generated using the structured language format, such as the XML, according to the second embodiment.

FIG. 18 illustrates a state where an evaluator C gives the Like attribute to a specific part “MAX 8192 KB” in a document D, and an evaluator D gives the Like attribute to a specific part (graph of Test4) in the document D in the second embodiment.

FIG. 19 collectively illustrates exemplary metadata created as an evaluation result by the evaluators B, C, and D in the second embodiment.

FIG. 20 illustrates an exemplary summary generated based on the metadata collected in the second embodiment.

FIG. 21 illustrates an exemplary summary D3 that describes breakdowns of given attributes in addition to a summary D2 in the second embodiment.

FIG. 22 illustrates steps of processing at the second phase of evaluating the document registered with the image forming apparatus according to the second embodiment.

FIG. 23 illustrates a concrete example of processing where two evaluators (evaluator A and evaluator B) evaluate a document with the image forming apparatus according to the second embodiment.

FIG. 24 illustrates a concrete example where a user who registers the document as the first phase also in charge of an evaluator for the second phase and collectively processes the first phase and the second phase in the second embodiment.

FIG. 25 illustrates steps of processing at the third phase where a summary of a document is created based on metadata regarding collected evaluations in the second embodiment.

FIG. 26 illustrates a concrete example until a user's instruction prints and outputs a summary at the third phase of the second embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes respective embodiments of the disclosure with reference to the drawings.

### Outline of First Embodiment

First, the following describes an outline of a first embodiment of the disclosure. The first embodiment includes processing constituted of three phases: “registration of document,” “evaluation on registered document,” and “utilization of evaluation on document as metadata.”

The first phase performs “registration of document.” Specifically, the first phase registers a document desired to be processed by a document processing device with the document processing device by the user. The registration may be performed as follows. A scanner reads a document printed on print media. The user registers electrical character data and image data formed by optical character recognition (OCR) processing with the document processing device. Alternatively, the user registers a document of electronic data from the beginning with the document processing device as it is.

The second phase performs “evaluation on registered document” at the first phase. The evaluation may be performed as follows. A member of a group where the user who has registered the document belongs to accesses the document processing device. An ordinary person unrelated to the user who has registered the document is allowed to access the document processing device. Thus, the evaluations may be collected. An evaluator specifies a part of the document registered with the document management apparatus and gives a “Like” (high evaluation) attribute to the specified part, thus conducting the evaluation.

The third phase performs “utilization of evaluation on document as metadata” of the documents collected at the second phase. Specifically, among the image data included in the registered documents, the third phase determines the image data to which the Like attribute has been given by many evaluators as data that should be shared aiming improvement in business efficiency. The third phase extracts and shares the part.

Through the above-described three phases, the metadata for evaluating the contents of the registered documents can be easily generated. Utilizing the created metadata, the image data included in the document can be efficiently shared.

The outline of the first embodiment of the disclosure is described above.

### Environment for Using Document Processing Device (First)

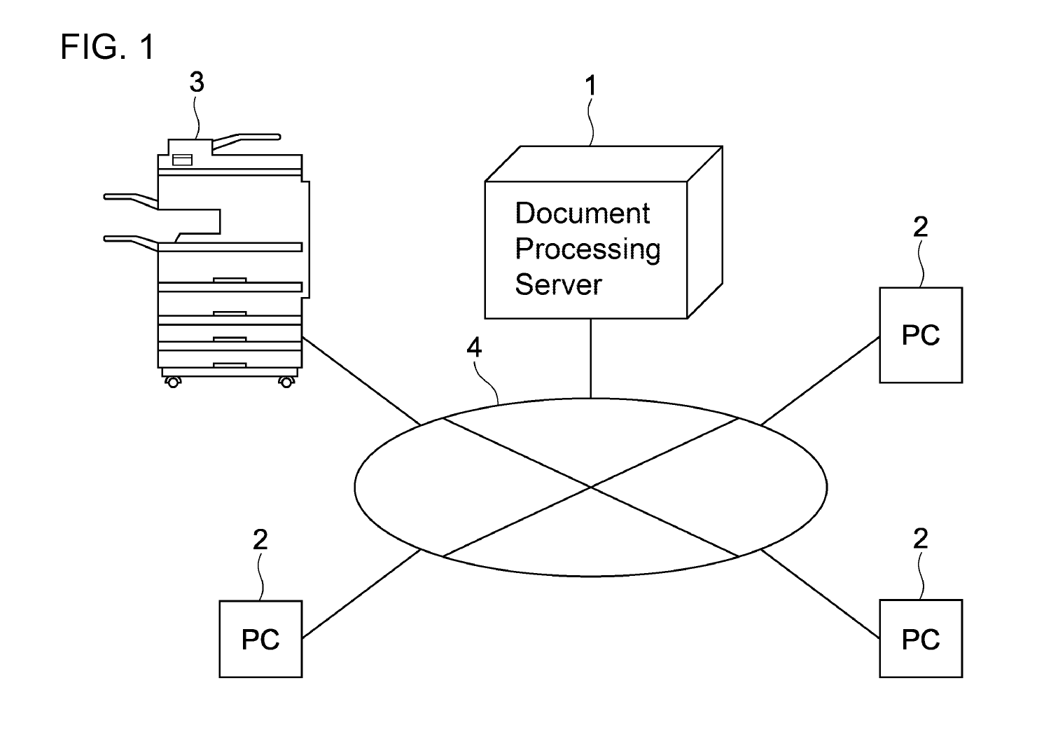

The following describes a specific exemplary configuration of a usage environment when achieving the document processing device according to the first embodiment of the disclosure using a general computer as the document processing server. FIG. 1 illustrates a concrete example of the usage environment when achieving the document processing device according to an embodiment of the disclosure using the general computer as a document processing server 1.

In this usage environment, the document processing server 1, which is the document processing device, is connected to a personal computer (PC) 2 and an image forming apparatus 3 via a network 4. The PC 2 and the image forming apparatus 3 may be plural.

In the first phase, which performs “registration of document,” for example, the user scans paper documents using a scanner function of the image forming apparatus 3. An OCR function that the image forming apparatus 3 has digitizes the documents as the character data and the image data. The image forming apparatus 3 registers the digitized documents with the document processing server 1 via the network 4.

The first phase may register electronic documents including the character data and the image data with the document processing server 1 from the PC 2 via the network 4.

In the second phase, which performs “evaluation on registered document,” to evaluate the document registered with the document processing server 1, the evaluator directly accesses the document using a display unit and an operation input unit included in the document processing server 1 or accesses the document from the PC 2 via the network 4.

The third phase, which performs “utilization of evaluation on document as metadata,” totalizes the Like attributes associated with the specific image data in the document at the second phase. Based on the totaled results, the third phase extracts and shares the image data. To use the shared image data, the user directly accesses the shared image data using the display unit and the operation input unit included in the document processing server 1 or accesses the shared image data from the PC 2 via the network 4.

The specific exemplary configuration of the usage environment when achieving the document processing device according to the embodiment of the disclosure using the general computer as the document processing server 1 is described above.

### Configuration of Document Processing Device (First)

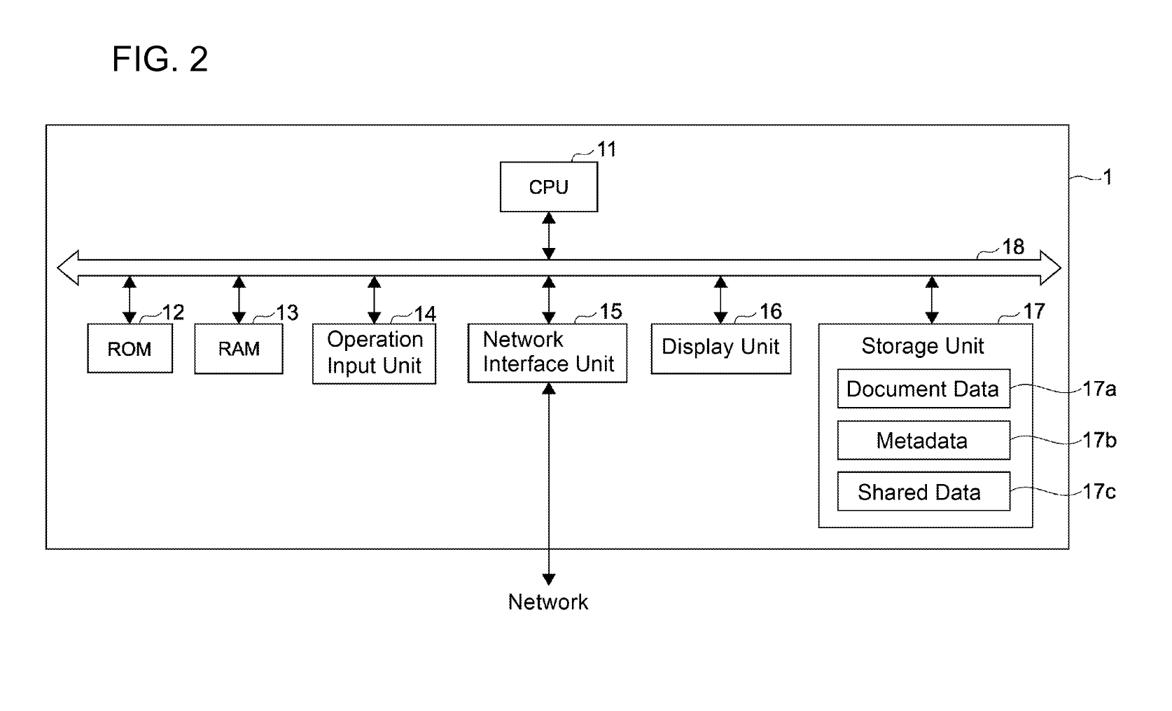

The following describes the configuration of the document processing server 1 used as the document processing device. FIG. 2 illustrates a configuration of the document processing server 1 used as the document processing device.

As illustrated in FIG. 2, the document processing server 1 includes a central processing unit (CPU) 11, a read only memory (ROM) 12, a random access memory (RAM) 13, an operation input unit (input circuit) 14, a network interface unit (output circuit) 15, a display unit (output circuit) 16, and a storage unit (storage circuit) 17. These respective blocks are connected via a bus 18.

The ROM 12 stores a plurality of programs, such as a firmware, and data to perform various processing tasks. The RAM 13 is used as a working area for the CPU 11. The RAM 13 temporarily holds an operating system (OS), various applications in execution, and various data in process.

The storage unit 17 is, for example, a hard disk drive (HDD), a flash memory, or other non-volatile memories. In addition to the OS and the various applications, the storage unit 17 stores document data 17a, metadata 17b, and shared data 17c. The document data 17a is of a document to be registered and evaluated. The metadata 17b is data such as the Like attribute given to a specific part by evaluating the document. The shared data 17c is formed by processing the document data 17a based on the metadata 17b and extracting and sharing the document data 17a. This configuration stores the shared data 17c in the storage unit 17 in the document processing server 1; however, the configuration is not limited to this. To share the image data extracted from the document based on the metadata 17b, the configuration where the extracted image data is transmitted to an external shared server may be used.

The network interface unit 15 is connected to the network 4. The network interface unit 15 exchanges information with the PC 2 and the image forming apparatus 3.

The CPU 11 expands a program corresponding to a command given via the operation input unit 14 and the network 4 among the plurality of programs stored in the ROM 12 and the storage unit 17 to the RAM 13. According to this expanded program, the CPU 11 appropriately controls the display unit 16 and the storage unit 17.

The CPU 11 stores the electronic document data input by the user for registration to the storage unit 17 via the network 4 and the network interface unit 15. The CPU 11 shows the stored document data 17a to the evaluator. The CPU 11 stores the Like attribute given to the specific part in the shown document by the evaluator in the storage unit 17 as the metadata 17b.

The CPU 11 extracts image data that should be shared from the document based on the stored metadata 17b. To share the extracted image data, the CPU 11 causes the storage unit 17 to store the image data as the shared data 17c.

The operation input unit 14 is, for example, a pointing device such as a computer mouse, a keyboard, a touch panel, and other operating devices.

The display unit 16 is, for example, a liquid crystal display, an electroluminescence (EL) display, a plasma display, and a cathode ray tube (CRT) display. The display unit 16 may be built into the document processing server 1 or may be externally connected.

The configuration of the document processing server 1 used as the document processing device is described above.

### Environment for Using Document Processing Device (Second)

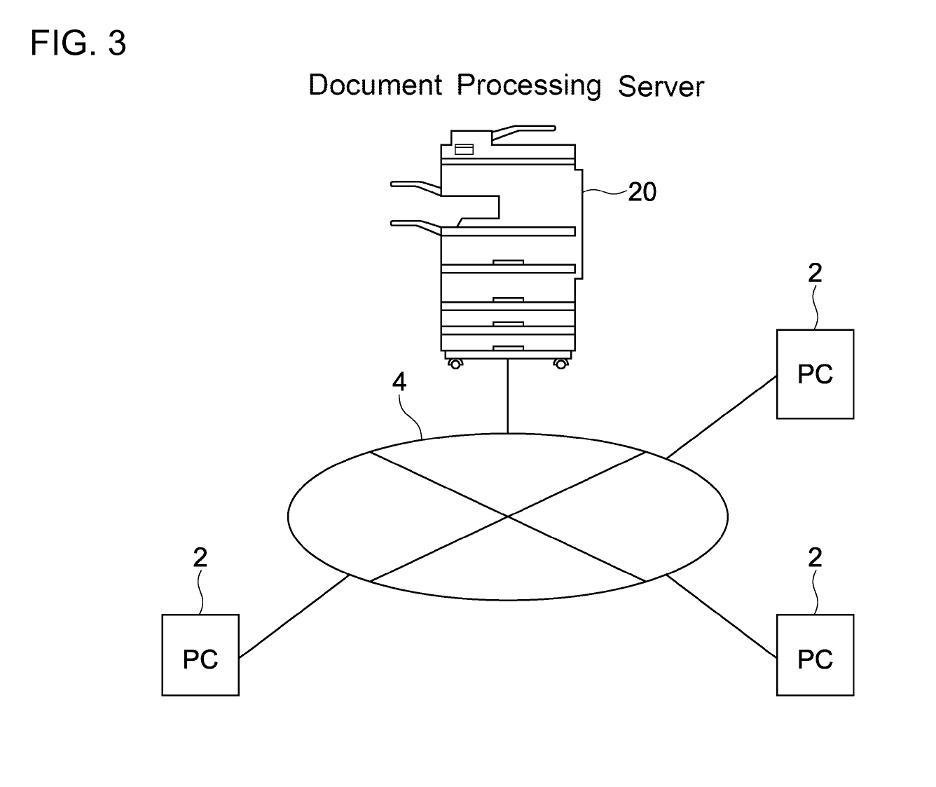

The following describes a configuration of concrete example of a usage environment when achieving the document processing device according to an embodiment of the disclosure as an image forming apparatus. FIG. 3 illustrates a configuration of concrete example of the usage environment when achieving the document processing device according to the embodiment of the disclosure as an image forming apparatus 20.

In this usage environment, the image forming apparatus 20, which is the document processing device, also serves as the document processing server 1 in the above-described example. That is, the image forming apparatus 20 is configured by integrating the functions of the above-described document processing server 1 and the general image forming apparatus 3.

Except the point that the image forming apparatus 20 also has the functions of the document processing server 1, the image forming apparatus 20 has the identical configuration to the configuration illustrated in FIG. 1. Therefore, the detailed description is omitted.

The configuration of concrete example of the usage environment when achieving the document processing device according to the embodiment of the disclosure as the image forming apparatus 20 is described above.

### Configuration of Document Processing Device (Second)

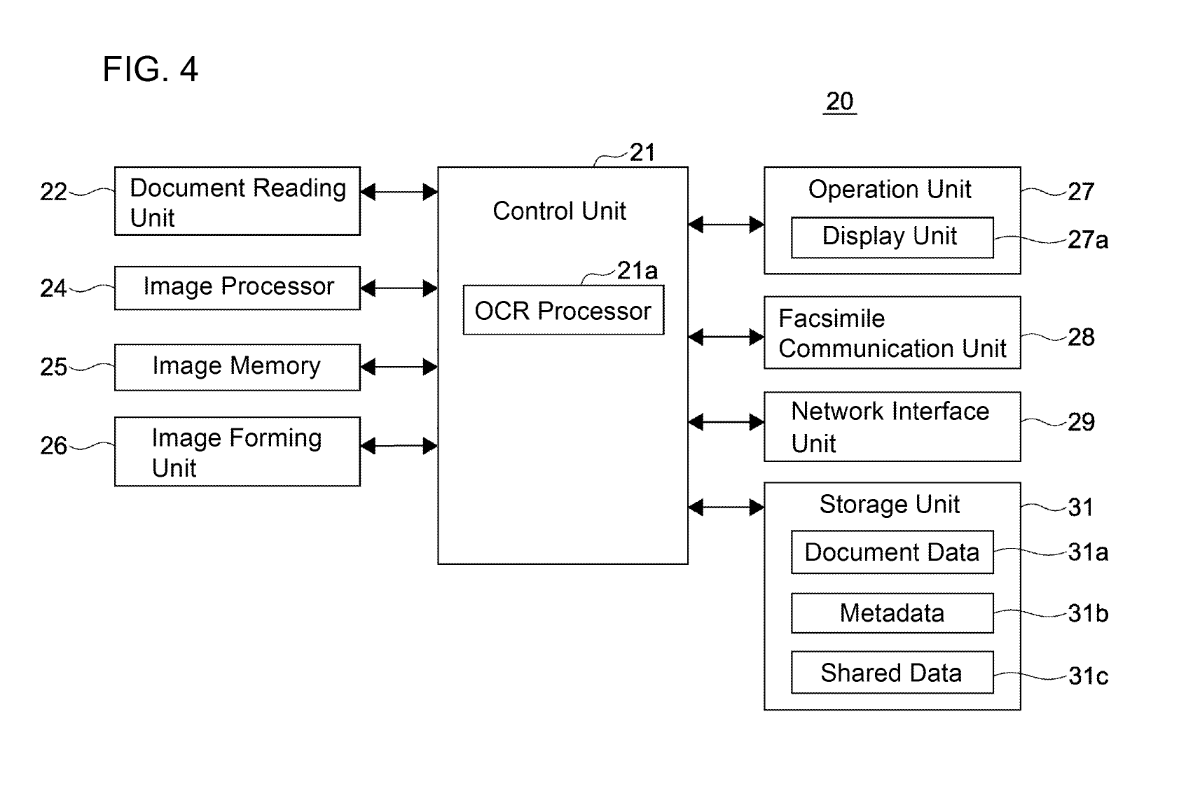

The following describes the configuration of the image forming apparatus 20 used as the document processing device. FIG. 4 illustrates the configuration of the image forming apparatus 20 used as the document processing device.

The image forming apparatus 20 includes a control unit 21. The control unit 21 is configured of a CPU, a RAM, a ROM, a dedicated hardware circuit, or a similar component. The control unit 21 manages overall operation control of the image forming apparatus 20.

The control unit 21 (control circuit) is connected to a document reading unit (scanner) 22, an image processor 24, an image memory 25, an image forming unit (output circuit) 26, an operation unit (input circuit) 27, a facsimile communication unit 28, a network interface unit (output circuit) 29, a storage unit 31, and a similar unit. The control unit 21 performs operation control on the connected respective units and transmits and receives signals or data to/from the respective units.

The control unit 21 stores the electronic document data input from the PC 2 by the user for registration to the storage unit 17 via the network 4 and the network interface unit 15. Alternatively, the control unit 21 performs OCR processing on the image data read by a document reading unit 22 by the user for registration and causes the storage unit 31 to store the image data as electronic document data 31a.

The control unit 21 shows the stored document data 31a to the evaluator via the display unit 27a or the network 4. The control unit 21 stores the Like attribute given to the specific part in the shown document by the evaluator as metadata 31b in storage unit 31.

The control unit 21 extracts image data that should be shared from the document based on the stored metadata 31b. To share the extracted image data, the control unit 21 causes the storage unit 31 to store the image data as shared data 31c.

The control unit 21 controls a driving and processing of a mechanism required to perform an operation control on each function, such as a scanner function, a printing function, a copy function, and a facsimile transmission/reception function according to an execution instruction of a job input by the user through the operation unit 27, the network-connected PC 2, or a similar unit.

The control unit 21 includes an OCR processor 21 a and a similar unit. The OCR processor 21a or a similar unit is a function block achieved by executing a program loaded from the ROM or a similar memory to the RAM by the CPU.

The OCR processor 21a performs the OCR processing on the image data read by the document reading unit 22, converts the image data into document data, and extracts the image data, such as a graph and a photograph.

The document reading unit 22 reads images from documents.

The image processor 24 performs image processing on the image data of the image read by the document reading unit 22 as necessary. For example, to improve a quality after image formation of the image read by the document reading unit 22, the image processor 24 performs the image processing such as a shading correction.

The image memory 25 is a region that temporarily stores data of the document image acquired by read by the document reading unit 22 and temporarily stores data of print target at the image forming unit 26.

The image forming unit 26 forms an image of the image data or similar data read by the document reading unit 22.

The operation unit 27 includes a touch panel unit and an operation key portion. The touch panel unit and the operation key portion accept instructions on various operations and processing executable by the image forming apparatus 20 from the user. The touch panel unit includes a display unit (output circuit) 27a, such as a liquid crystal display (LCD), with the touch panel.

The facsimile communication unit 28 includes an encoding/decoding unit, a modulation/demodulation unit, and a network control unit (NCU). The facsimile communication unit 28 performs transmission with a facsimile using a public telephone line network.

The network interface unit 29 is configured of a communication module such as a LAN board. The network interface unit 29 transmits and receives various data to/from a device in a local area (such as the PC) via the LAN or a similar medium connected to the network interface unit 29.

The storage unit 31 stores the document image read by the document reading unit 22, the document data 31a, the metadata 31b, and the shared data 31c. The storage unit 31 is a large-capacity storage device such as an HDD. The document data 31a, the metadata 31b, and the shared data 31c are identical to the above-described document data 17a, metadata 17b, and shared data 17c, respectively.

This configuration employs a configuration of storing the shared data 31c in the storage unit 31 in the image forming apparatus 20. However, the configuration is not limited to this. To share the image data extracted from the document based on the metadata 31b, the configuration of transmitting the extracted image data to the external shared server may be employed.

The configuration of the image forming apparatus 20 used as the document processing device is described above.

### Method for Giving Like Attribute

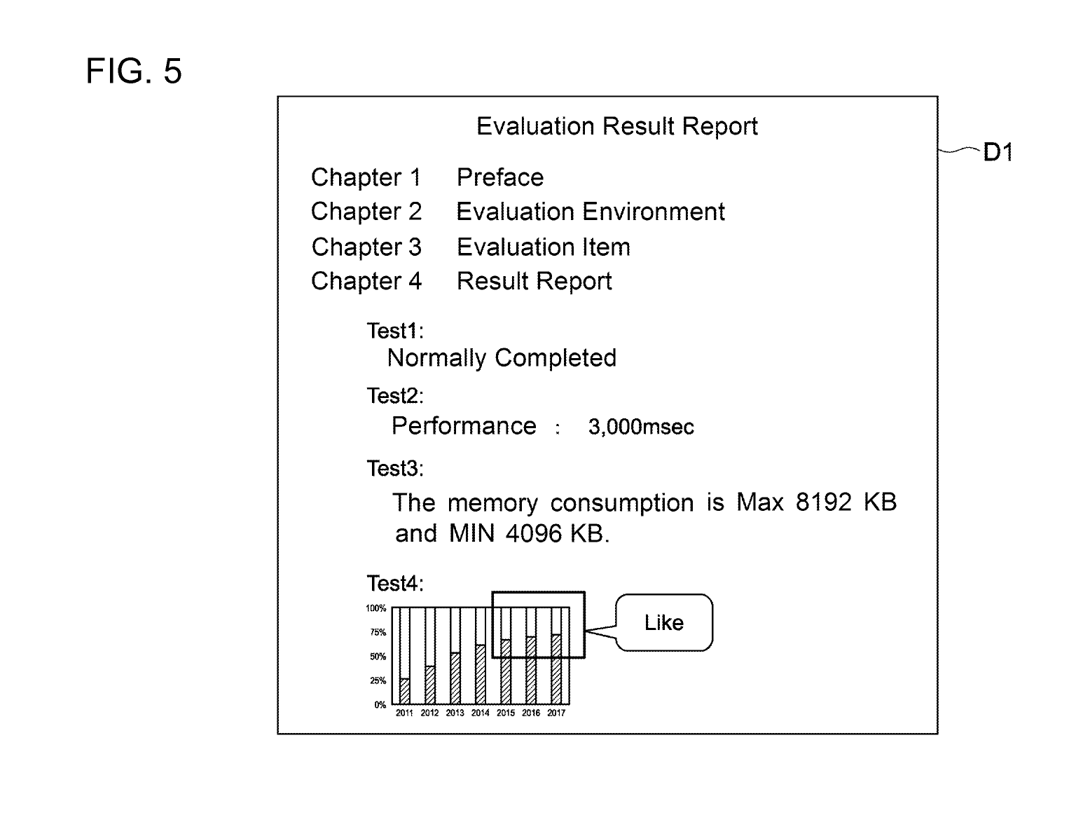

The following describes a state where the evaluator gives the Like attribute to the specific part specified by the evaluator in the document registered with the document processing server 1 or the image forming apparatus 20 in the above-described second phase with a concrete example. FIG. 5 illustrates a concrete example of a state where the evaluator gives the Like attribute to the specific part specified by the evaluator in the registered document with the document processing server 1 or the image forming apparatus 20. The following example describes using the document processing server 1 as the document processing device.

First, assume that an evaluator A registers the document D named “Evaluation Result Report” with the document processing server 1.

Next, assume that the evaluator B browses the document D on a browse screen D1 using an application program for document evaluation. Then, assume that the evaluator B views the graph illustrated in the “Test4” item in “Chapter 4 Result Report” and gives high evaluation to the part of the graph. Specifically, the evaluator B specifies the range of graph to be evaluated on the browse screen D1 and presses a Like button to give the evaluation result.

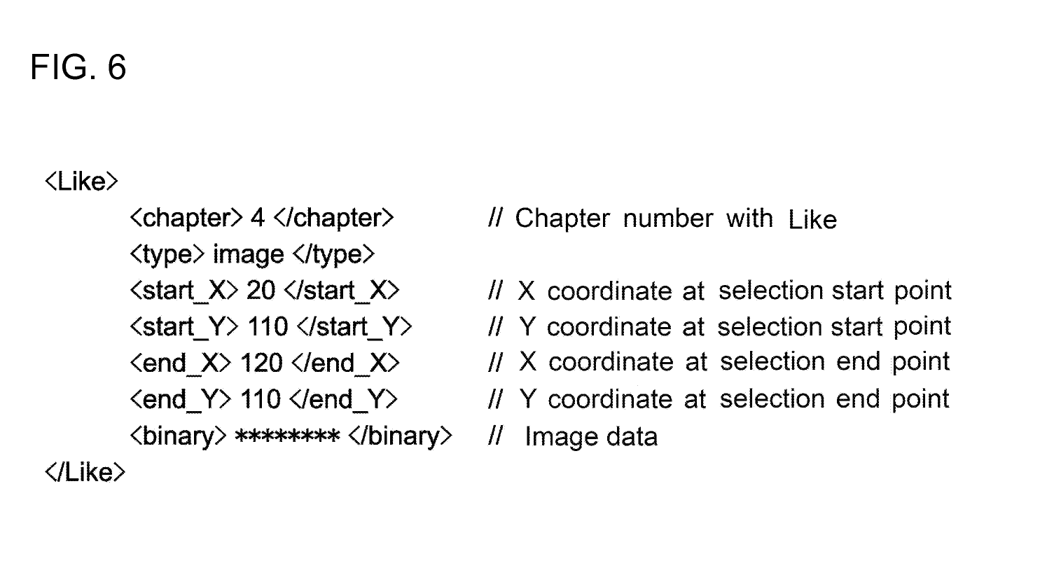

When the evaluator B clicks the Like button, the application program for document evaluation, for example, as illustrated in FIG. 6, uses a structured language format such as an Extensible Markup Language (XML) to generate the metadata 17b.

This metadata 17b in structured language format records the fact that the part selected by the evaluator is the image data (image), a chapter number, X and Y coordinates for a selection start point, and X and Y coordinates for a selection end point. Furthermore, as one file including the selected range and being a meaningful unit, the file name of the image data may be recorded to the <binary> tag.

The state where the evaluator gives the Like attribute to the specific part specified by the evaluator in the document registered with the document processing server 1 or the image forming apparatus 20 is described above with the concrete example.

### Criteria of Extraction for Sharing

The following describes criteria of which image data is extracted for sharing among the image data to which the Like attributes are given in the document.

As criteria for extraction, for example, the Like attribute is given, the Like attribute is given by equal to or more than a specific count of evaluators, or a similar citation can be fixed.

The disclosure is premised that the image data having a part to which the evaluator gives high evaluation and pays attention is the image data that can improve business efficiency by being shared. Accordingly, based on the count of given Like attributes, the disclosure determines whether to extract the specific image data for sharing or not.

The criteria of which image data is extracted for sharing among the image data to which the Like attributes are given in the document are described above.

### Flow of Processing

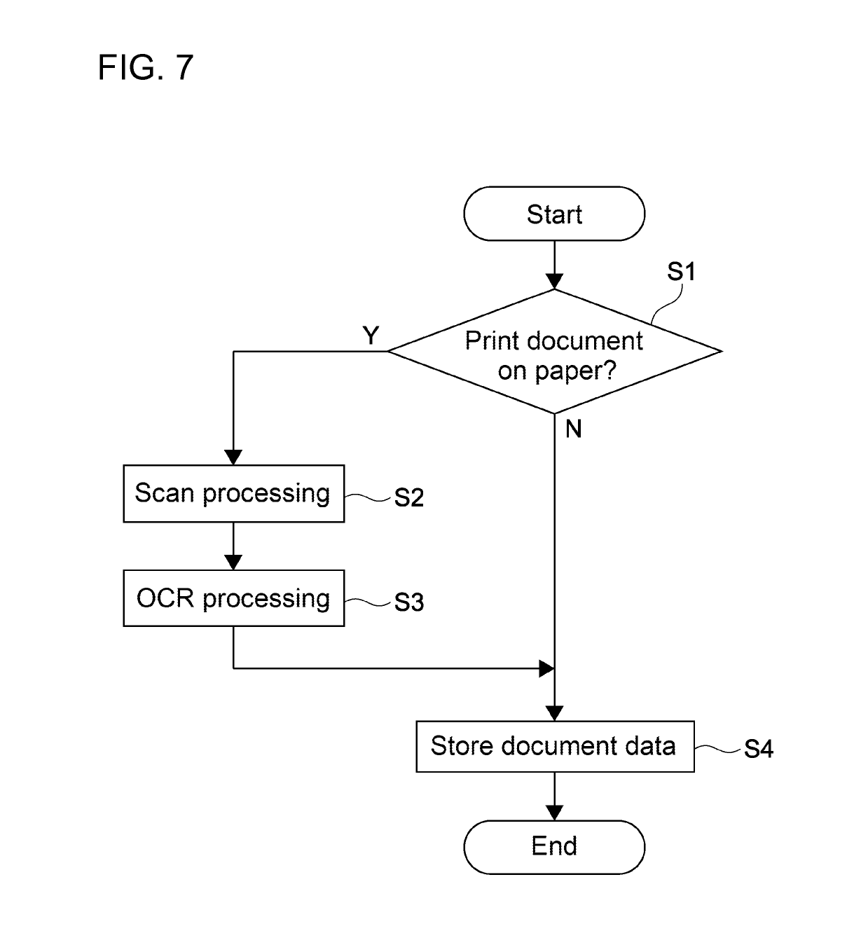

The following describes the flow of processing performed on the document processing server 1 and the image forming apparatus 20, which are the document processing devices. FIGS. 7 to 12 are flowcharts and sequence diagrams for describing the flow of processing performed by the document processing server 1 and image forming apparatus 20, which are the document processing devices.

The following description describes with the example of the image forming apparatus 20. The description is described divided from the first phase to the third phase.

### First Phase (Registration of Document)

First, the following describes the flow of processing of the first phase that registers the evaluated document with the image forming apparatus 20. FIG. 7 illustrates steps of processing at the first phase of registering the document to be evaluated with the image forming apparatus 20.

First, the first phase determines whether the document that the user registers for evaluation has been printed on a paper or not (Step S1).

If printed on the paper (Y at Step S1), the user gives an instruction to the control unit 21 via the operation unit 27 to cause the document reading unit 22 to scan the print media (Step S2).

Next, the control unit 21 causes the OCR processor 21a to perform the OCR processing on scan data (Step S3). The storage unit 31 stores the data after OCR processing.

If the document is not printed on the print media (N at Step S1) or after the OCR processing is terminated, the document data constituting the document are constituted by the electronic character data and the image data. The electronic character data and the image data are stored in the storage unit 31 as it is (Step S4).

### Second Phase (Evaluation on Registered Document)

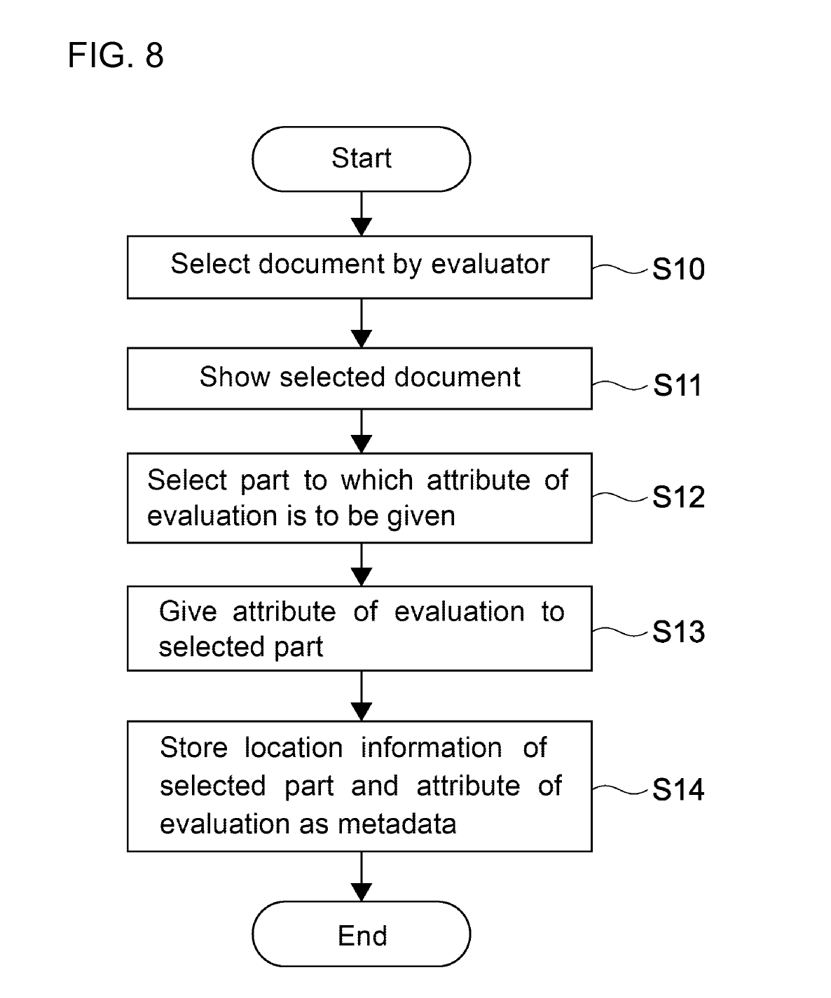

The following describes the flow of processing at the second phase of evaluating the document registered with the image forming apparatus 20. FIG. 8 illustrates steps of processing at the second phase of evaluating the document registered with the image forming apparatus 20.

First, the evaluator who evaluates the document gives an instruction to the image forming apparatus 20 to select an evaluated document (Step S10).

Next, the control unit 21 of the image forming apparatus 20 shows the selected document to the evaluator via the display unit 27a (Step S11).

Next, the evaluator selects the part to which the attribute of high evaluation (evaluation result) is to be given (evaluated part) in the shown document (Step S12).

Next, the evaluator presses the Like button to the part selected at the previous step to give the attribute of evaluation (Step S13).

Next, the control unit 21 of the image forming apparatus 20 causes the storage unit 31 to store the location information of the part selected by the evaluator and the given attribute of evaluation as the metadata 31b (Step S14).

### Concrete Example of Second Phase

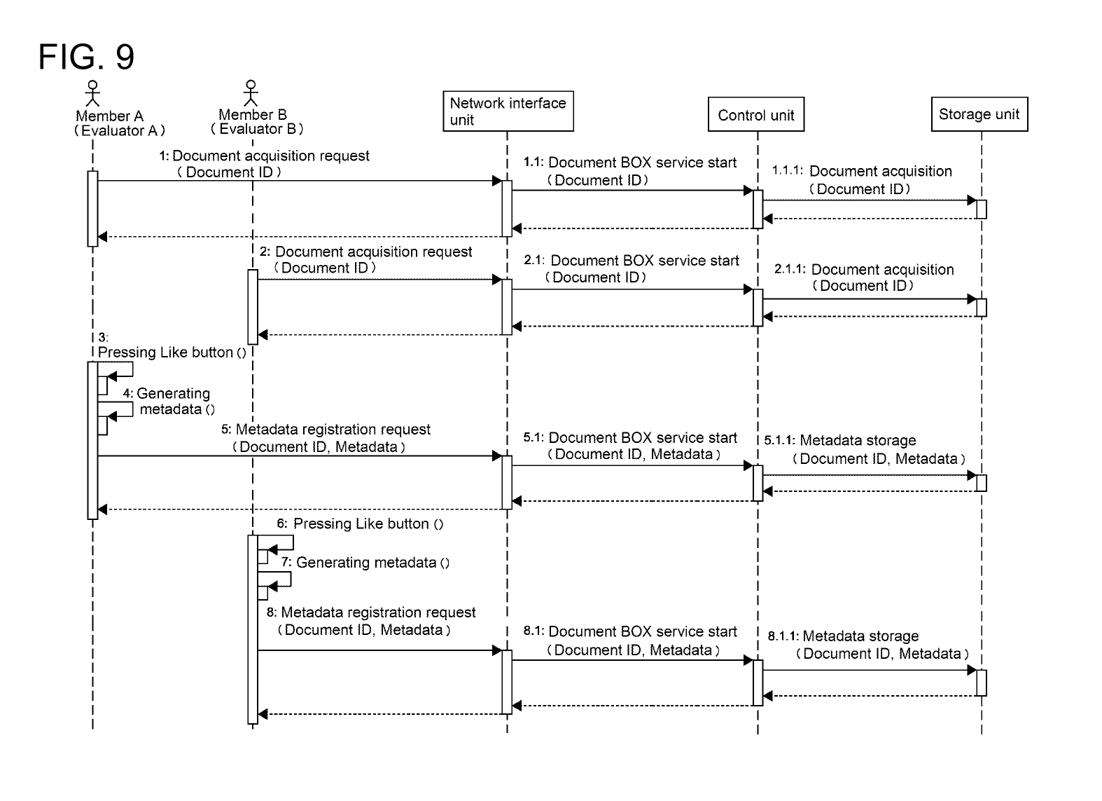

The following describes a concrete example of processing where the two evaluators (evaluator A and evaluator B) evaluate the document with the image forming apparatus 20. FIG. 9 illustrates the concrete example of processing where the two evaluators (evaluator A and evaluator B) evaluate the document with the image forming apparatus 20.

In the example illustrated in FIG. 9, the following is assumed. The evaluator A and the evaluator B access from another PC 2 to the image forming apparatus 20. On the PC 2, the selected document is evaluated using the above-described application program for document evaluation.

First, the evaluator A specifies a document ID and acquires the document data 31a stored in the storage unit 31 via the network interface unit 29 and the control unit 21 of the image forming apparatus 20.

Specifically, as illustrated in FIG. 9, first, the evaluator A specifies the document ID via the PC 2 for evaluator A and transmits a document acquisition request to the network interface unit 29. Next, the network interface unit 29 transmits the document ID to the control unit 21. When the control unit 21 receives the document ID, the control unit 21 starts document BOX service and acquires the document data 31a corresponding to the document ID from the storage unit 31. The control unit 21 transmits the acquired document data 31a to the PC 2 for evaluator A via the network interface unit 29. Thus, the evaluator A acquires the document data 31a. The document BOX service is provided to manage inputs and outputs of the document data 31a stored in the storage unit 31 or a similar operation.

Next, the evaluator B acquires the document data 31a similar to the processing by the evaluator A.

Next, the evaluator A selects the part to which the attribute of evaluation is to be given in the acquired document data 31a and presses the Like button to give the attribute of evaluation. Accordingly, the application program for document evaluation, which operates on the PC 2, generates the metadata 31b (the metadata 31b may be generated on the image forming apparatus 20 or may be generated on the PC 2).

Next, the application program for document evaluation used by the evaluator A specifies the document ID and causes the storage unit 31 to store the generated metadata 31b via the network interface unit 29 and the control unit 21 of the image forming apparatus 20.

Specifically, as illustrated in FIG. 9, first, the PC 2 for evaluator A transmits the document ID and the metadata 31b to the network interface unit 29. Next, the network interface unit 29 transmits the document ID and the metadata 31b to the control unit 21. When the control unit 21 receives the document ID and the metadata 31b, the control unit 21 starts the document BOX service, associates the metadata 31b with the document ID, and causes the storage unit 31 to store the metadata 31b and the document ID. Afterwards, the control unit 21 notifies the PC 2 for evaluator A of the registration of evaluation by the evaluator A via the network interface unit 29.

Next, the evaluator B also performs the processing similar to the case of the evaluator A.

When generating the metadata 31b on the image forming apparatus 20, the PC 2 transmits a generation request of the document ID and the metadata 31b (including information on the attribute and the part of given evaluation) to the network interface unit 29. The network interface unit 29 transmits the generation request of the document ID and the metadata 31b to the control unit 21. The control unit 21 generates the metadata 31b corresponding to the generation request.

### Concrete Example of Collectively Performing First Phase and Second Phase

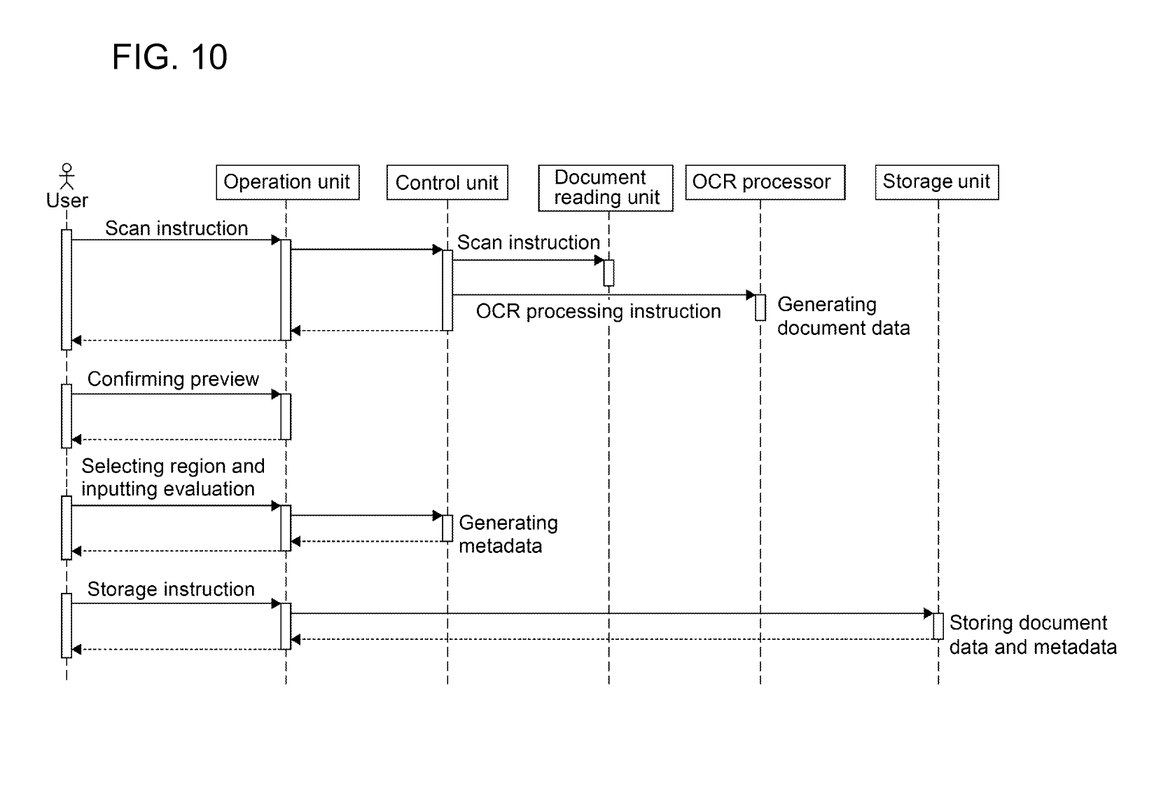

The following describes a concrete example where the user who registers the document as the first phase also in charge of an evaluator for the second phase and collectively processes the first phase and the second phase. FIG. 10 illustrates the concrete example where the user who registers the document as the first phase also in charge of the evaluator for the second phase and collectively processes the first phase and the second phase.

First, the user instructs the control unit 21 to digitize the document printed on the paper via the operation unit 27.

Next, the control unit 21 instructs the document reading unit 22 to scan the document.

Next, the control unit 21 gives an instruction to the OCR processor 21a. The OCR processor 21a converts the scanned image data into the character data to generate the document data. Next, to confirm a preview, the control unit 21 displays the generated document data on the display unit 27a of the operation unit 27.

Next, the user as the evaluator selects the part to which the attribute of evaluation is to be given and gives the attribute of high evaluation to the selected part.

Next, the control unit 21 generates the metadata 31b including the location information of the part selected by the user and the attribute of evaluation.

Next, based on the user's instruction, the control unit 21 causes the storage unit 31 to store the generated document data 31a and metadata 31b.

Finally, the control unit 21 displays the registration of the evaluation by the evaluator A on the display unit 27a.

### Third Phase (Utilization of Evaluation on Document as Metadata)

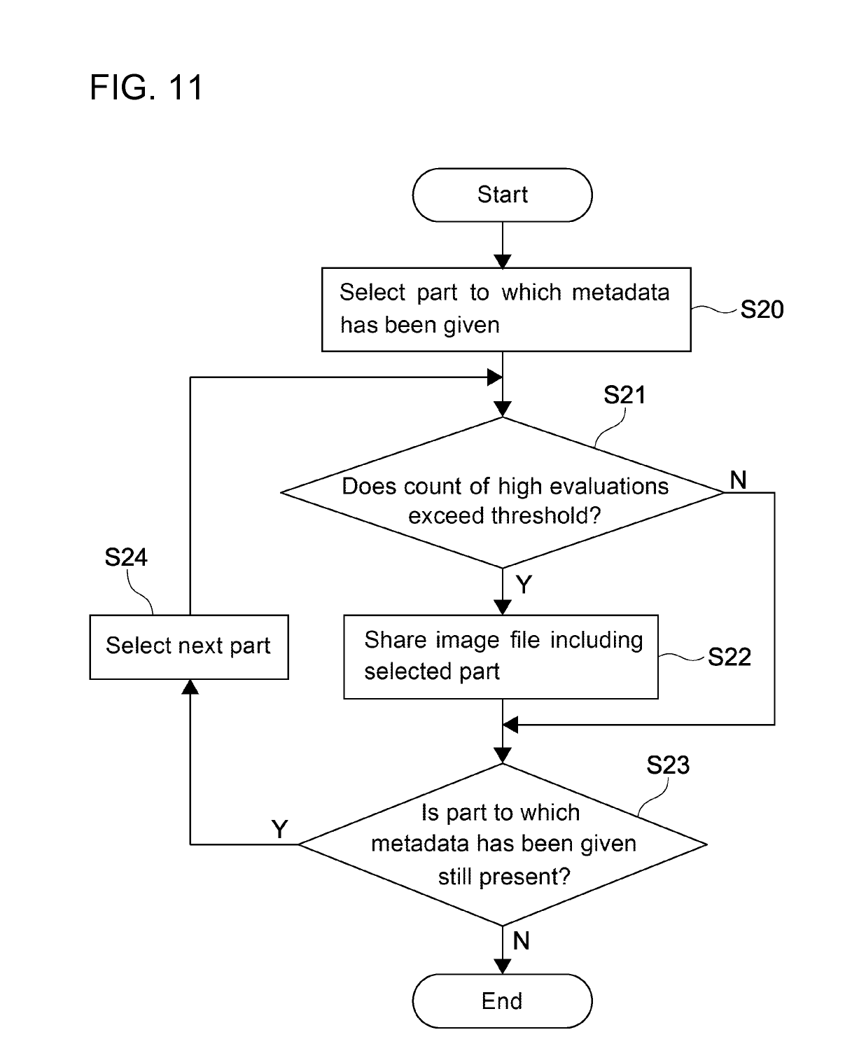

The following describes the flow of processing at the third phase that shares the image data included in the document based on the metadata regarding the collected evaluations. FIG. 11 illustrates steps of processing at the third phase where the image data included in the document is shared based on the metadata regarding the collected evaluations.

First, the control unit 21 searches the location information of the part to which the metadata 31b has been given in the document including the image data to be shared. Based on the search result, the control unit 21 selects one part among the parts to which the metadata 31b have been given (Step S20).

Next, the control unit 21 determines whether a sum of evaluation results of high evaluation given to the selected part exceeds a specific threshold or not (Step S21).

When the sum of high evaluations given to the selected part exceeds the specific threshold (Y at Step S21), the control unit 21 extracts a meaningful unit including the selected part (here, one image file) for sharing (Step S22). Here, the part where the sum of high evaluations exceeds the specific threshold is extracted. However, the configuration is not limited to this. The evaluated part with the location information may be extracted. Alternatively, the evaluated part with the location information and the evaluation result may be extracted.

Next, the control unit 21 determines whether the part to which the metadata 31b has been given is still present or not (Step S23).

If the part to which the metadata 31b has been given is still present (Y at Step S23), the control unit 21 selects the part next to the part to which the metadata 31b has been given (Step S24) and returns to the processing at Step S21.

### Concrete Example of Collectively Performing Second Phase and Third Phase

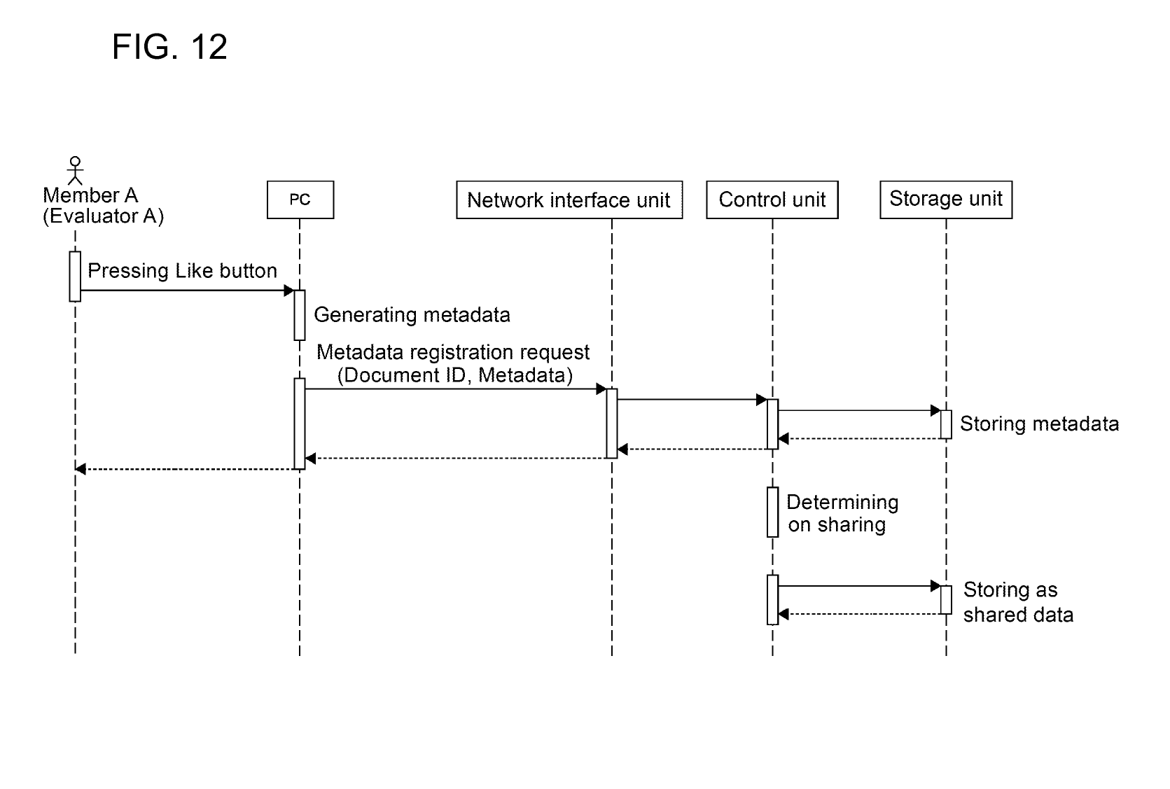

The following describes a concrete example of collectively processing the second phase and the third phase. FIG. 12 illustrates the concrete example of collectively processing the second phase and the third phase. The drawing illustrates omitting a process where the PC 2 used by the evaluator A acquires the document evaluated by the evaluator A from the image forming apparatus 20 from the second phase.

First, the evaluator A selects the part to be evaluated among the image data in the acquired document.

The evaluator A presses the Like button to the selected part to give the evaluation of high evaluation.

Next, the application program for document evaluation on the PC 2 generates the metadata 31b using the location information of the selected part and the attribute of high evaluation given to the selected part.

Next, the application program for document evaluation on the PC 2 transmits the generated metadata 31b together with the document ID of the evaluated document to the network interface unit 29 of the image forming apparatus 20.

The control unit 21 that receives the metadata 31b via the network interface unit 29 causes the storage unit 31 to store the metadata 31b.

Next, the control unit 21 determines whether the image data indicated by the metadata 31b meets the criteria that the image data should be shared or not by the stored metadata 31b.

When the image data meets the criteria that the image data should be shared, the control unit 21 causes the storage unit 31 to store the metadata 31b as the shared data 31c.

The flow of processing performed on the document processing server 1 and the image forming apparatus 20, which are the document processing devices, is described above. Exemplary Utilization of Shared Image Data

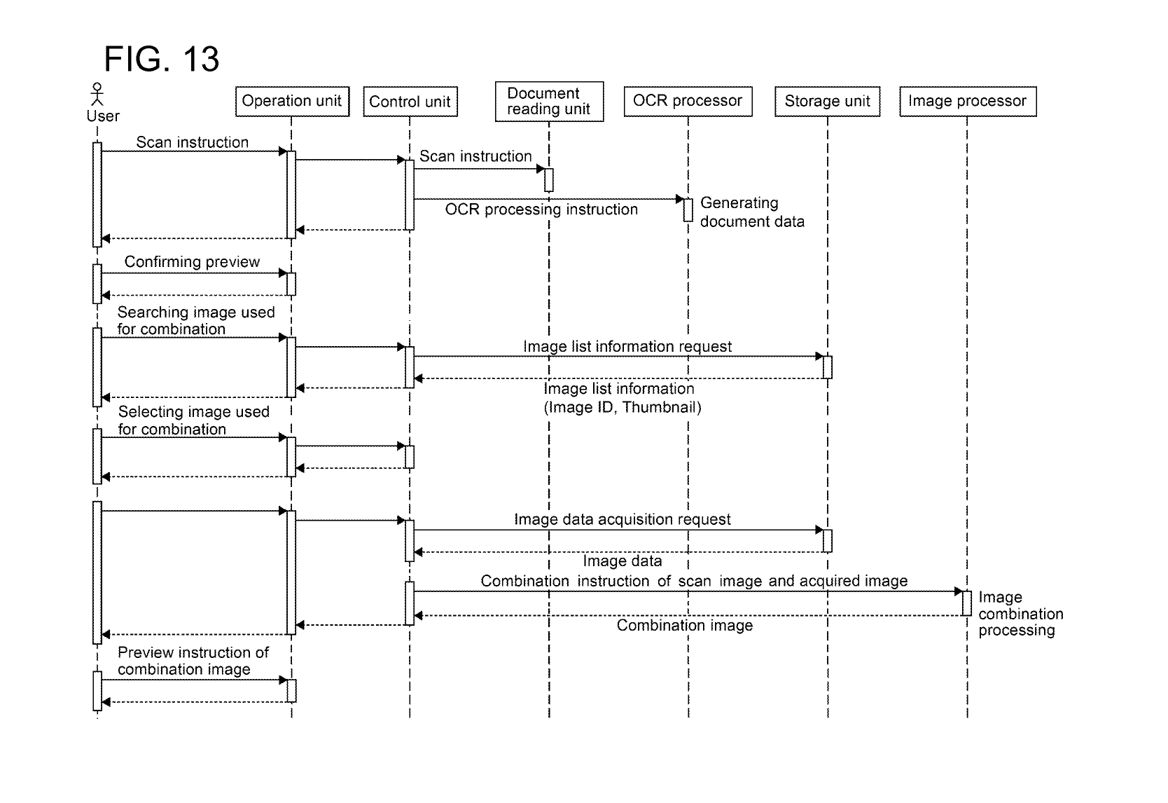

The following describes an exemplary utilization of shared image data performed after sharing the image data in the third phase. FIG. 13 illustrates the exemplary utilization of the shared image data performed after sharing the image data in the third phase.

First, the user causes the document reading unit 22 of the image forming apparatus 20 to scan the paper document on which image data to be combined with the shared image data is printed.

That is, the user instructs the control unit 21 to electronize the document printed on the paper via the operation unit 27. The control unit 21 gives an instruction to the document reading unit 22 to scan the document.

Next, the control unit 21 gives an instruction to the OCR processor 21a. The OCR processor 21a converts the scanned image data into the character data to generate the document data.

Next, to confirm a preview, the control unit 21 displays the generated document data on the display unit 27a of the operation unit 27.

Next, the user instructs the control unit 21 to show the list of the image data used for combination to the user via the operation unit 27 of the image forming apparatus 20. Corresponding to the instruction, the control unit 21 acquires the list of image data used for combination from the storage unit 31 and displays the list on the display unit 27a.

Next, the user selects the image data used for combination of the image from the list of image data shown via the operation unit 27.

Next, the user instructs the control unit 21 to acquire the image data used for combination via the operation unit 27 of the image forming apparatus 20. The control unit 21 acquires the image data selected from the list from the storage unit 31 according to the instruction.

Next, the control unit 21 instructs the image processor 24 to combine the acquired image data and the image data on the paper document scanned first.

Next, the image processor 24 combines the plurality of image data.

Next, the user previews the combined image data.

The exemplary utilization of the shared image data performed after sharing the image data in the third phase in the first embodiment is described above.

### Outline of Second Embodiment

The following describes an outline of a second embodiment of the disclosure. The second embodiment is similar to the first embodiment in that the first embodiment includes processing constituted of three phases: “registration of document,” “evaluation on registered document,” and “utilization of evaluation on document as metadata.”

The first phase performs “registration of document” similar to the first embodiment.

The second phase conducts evaluation as follows. The evaluator specifies a part of the document registered with the document management apparatus. The evaluator gives not only the “Like” (high evaluation) attribute to the specific part but also gives the “Dislike” (low evaluation) attribute.

The third phase performs “utilization of evaluation on document as metadata” of the documents collected at the second phase. Specifically, among the registered documents, the part to which the Like attributes and the Dislike attributes are given by many evaluators is determined as an important part of highly attracted. The third phase extracts the part to create the summary of the registered document.

Through the above-described three phases, the metadata for evaluating the contents of the registered documents can be easily created. Based on the created metadata, the document can be summarized.

The outline of the second embodiment of the disclosure is described above.

### Environment for Using Document Processing Device (First)

Next, the document processing device according to the second embodiment of the disclosure is identical to the first embodiment in the first phase and the second phase.

The third phase, which performs “utilization of evaluation on document as metadata,” totalizes the Like attributes and the Dislike attributes associated with the specific part in the document at the second phase and creates the summary of the document. To view the generated summary, the user directly accesses the summary using the display unit and the operation input unit included in the document processing server 1 or accesses the summary from the PC 2 via the network 4.

The specific exemplary configuration of the usage environment when achieving the document processing device according to an embodiment of the disclosure using the general computer as the document processing server 1 is described above.

### Configuration of Document Processing Device (First)

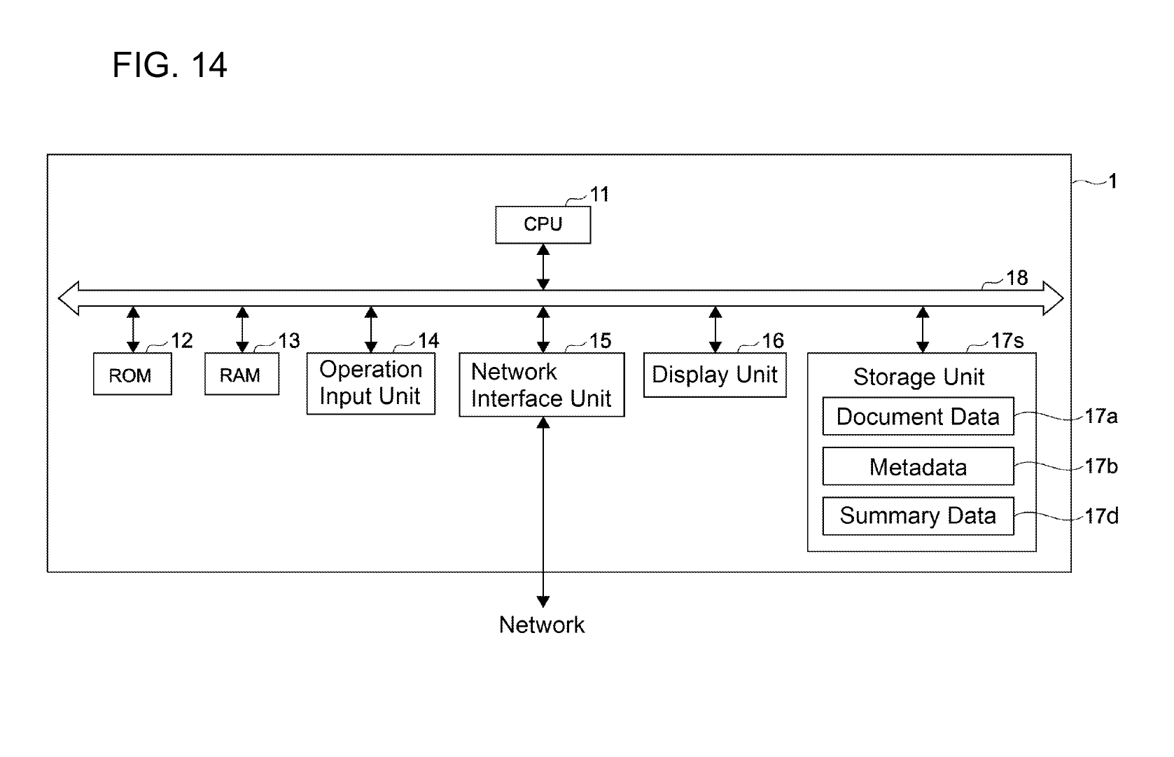

Next, the configuration of the document processing server 1 used as the document processing device according to the second embodiment is identical to the configuration of the document processing server 1 used as the document processing device according to the first embodiment. However, processing items differ in the following point. FIG. 14 illustrates the configuration of the document processing server 1 used as the document processing device.

In addition to the OS and the various applications, a storage unit 17s stores the document data 17a, the metadata 17b, and summary data 17d. The document data 17a is of a document to be registered and evaluated. The metadata 17b is data such as the Like attribute and the Dislike attribute given to the specific part by evaluating the document. The summary data 17d is created by processing the document data 17a based on the metadata 17b.

The CPU 11 shows the stored document data 17a to the evaluator. The CPU 11 stores the Like attribute and the Dislike attribute given to the specific part in the shown document by the evaluator in the storage unit 17s as the metadata 17b.

Then, the CPU 11 creates the summary of the document as the summary data 17d based on the stored metadata 17b and provides the generated summary to the user.

The configuration of the document processing server 1 used as the document processing device according to the second embodiment is described above.

### Configuration of Document Processing Device (Second)

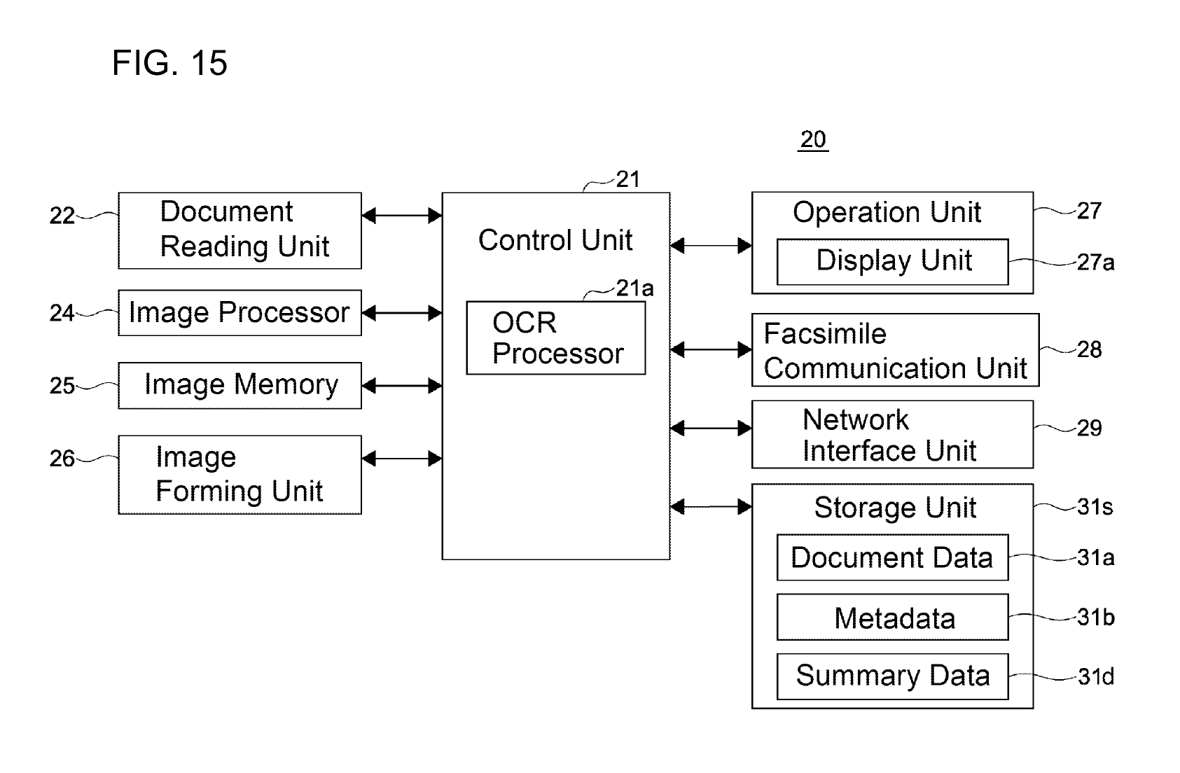

Next, the configuration of the image forming apparatus 20 used as the document processing device is identical to the configuration of the image forming apparatus 20 used as the document processing device according to the first embodiment. However, processing items differ in the following point. FIG. 15 illustrates a configuration of an image forming apparatus 20 used as the document processing device.

The control unit 21 shows the stored document data 31a to the evaluator via the display unit 27a or the network 4. The control unit 21 stores the Like attribute and the Dislike attribute given to the specific part in the shown document by the evaluator as the metadata 31b in the storage unit 31s.

Then, the control unit 21 creates the summary of the document as summary data 31d based on the stored metadata 31b and provides the generated summary to the user.

The storage unit 31s stores the document image read by the document reading unit 22, the document data 31a, the metadata 31b, and the summary data 31d. The storage unit 31s is a large-capacity storage device such as an HDD. The document data 31a, the metadata 31b, and the summary data 31d are identical to the above-described document data 17a, metadata 17b, and summary data 17d, respectively.

The configuration of the image forming apparatus 20 used as the document processing device is described above.

### Method for Giving Like Attribute and Dislike Attribute

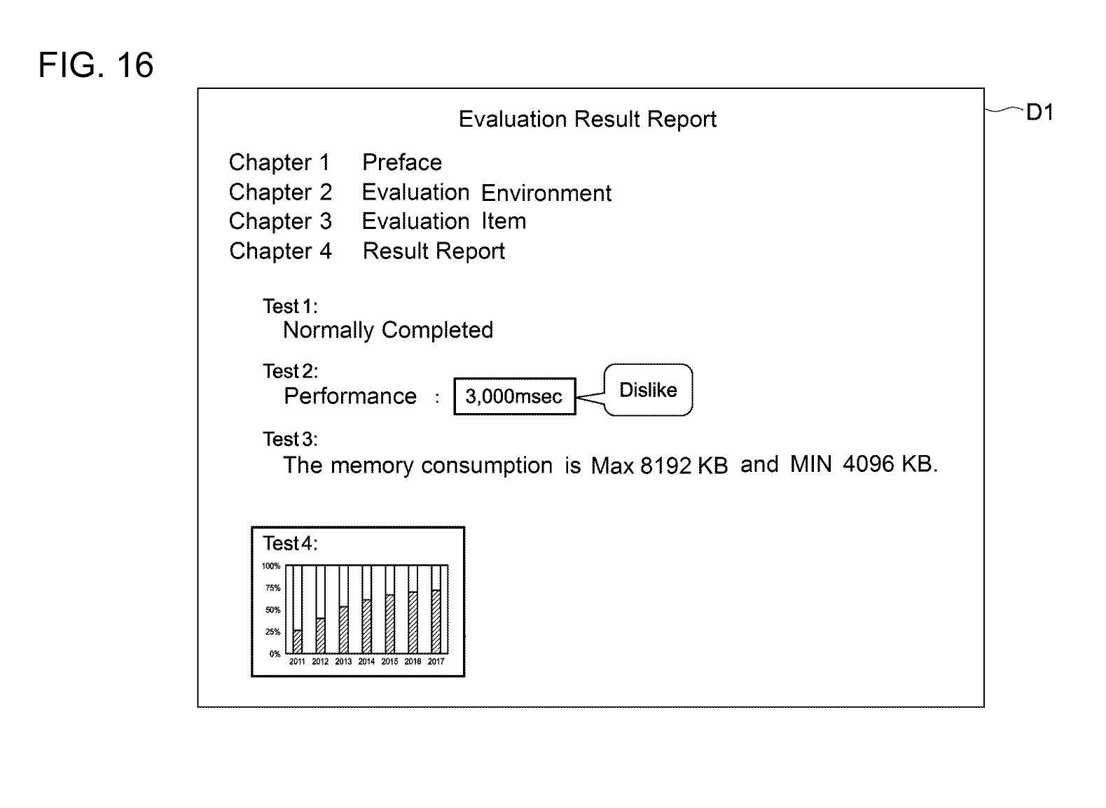

The following describes a state where the evaluator gives the Like attribute or the Dislike attribute to the specific part specified by the evaluator in the document registered with the document processing server 1 or the image forming apparatus 20 in the above-described second phase with a concrete example. FIG. 16 illustrates the concrete example a state where the evaluator gives the Like attribute or the Dislike attribute to the specific part specified by the evaluator in the registered document with the document processing server 1 or the image forming apparatus 20. The following example describes using the document processing server 1 as the document processing device.

First, assume that the evaluator A registers the document D named “Evaluation Result Report” with the document processing server 1.

Next, the evaluator B browses the document D on the browse screen D1 using the application program for document evaluation. Then, assume that the evaluator B views that the value of “Performance,” which is described in the “Test2” item in “Chapter 4 Result Report,” is “3,000 msec” and dislikes the value.

To evaluate that the evaluator B dislikes this value, the evaluator B selects the “3,000 msec” part on the browse screen D1 and clicks the Dislike button.

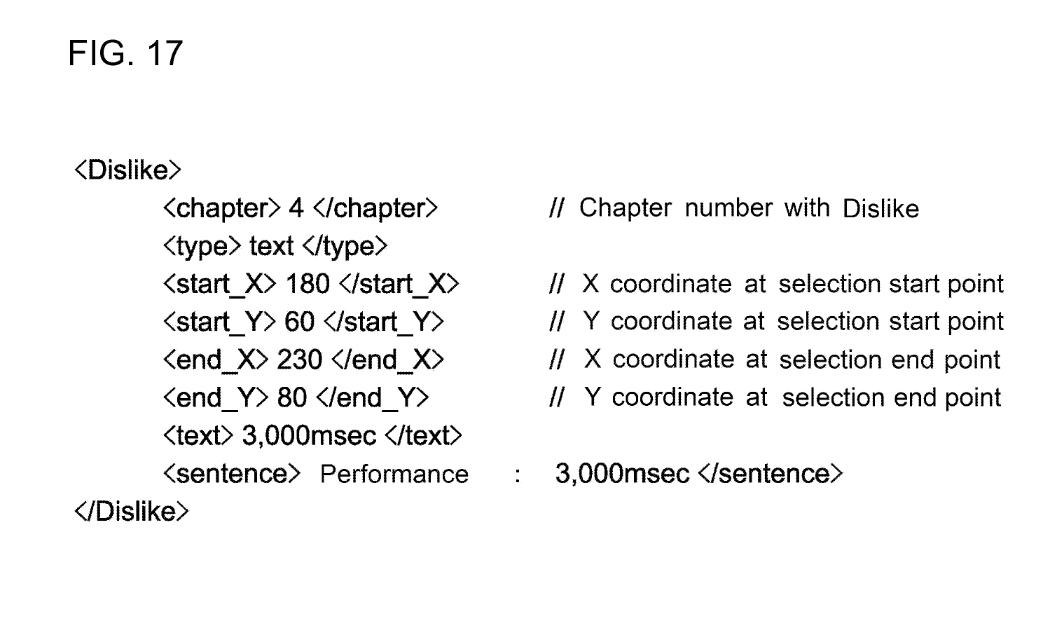

When the evaluator clicks the Like button or the Dislike button, the application program for document evaluation, for example, as illustrated in FIG. 17, uses the structured language format such as the Extensible Markup Language (XML) to generate the metadata 17b.

The metadata 17b in structured language format records the fact that the part selected by the evaluator is a character string (text), the chapter number, the X and Y coordinates for the selection start point, the X and Y coordinates for the selection end point, and the selected character string. Furthermore, as one sentence including the selected character string and being a meaningful unit, the “Performance: 3,000 msec” may be recorded to the <sentence> tag.

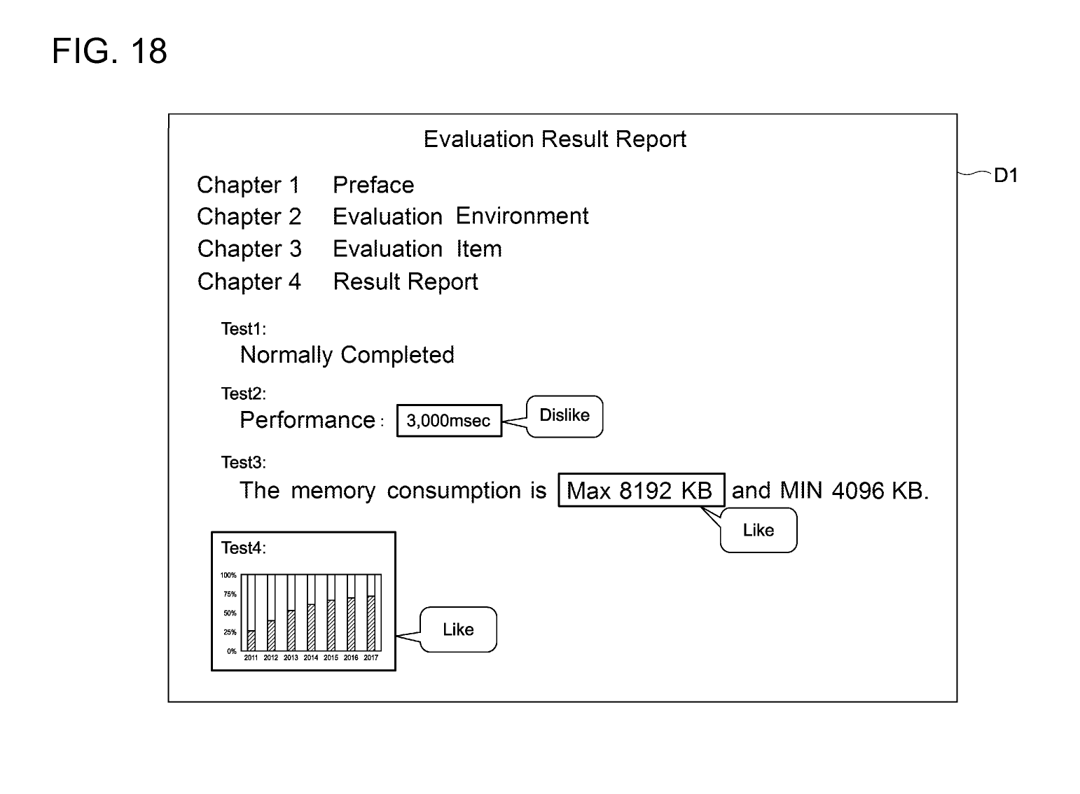

Similarly, FIG. 18 illustrates a state where the evaluator C gives the Like attribute to a specific part “MAX 8192 KB” in the document D, and an evaluator D gives the Like attribute to a specific part (graph of Test4) in the document D.

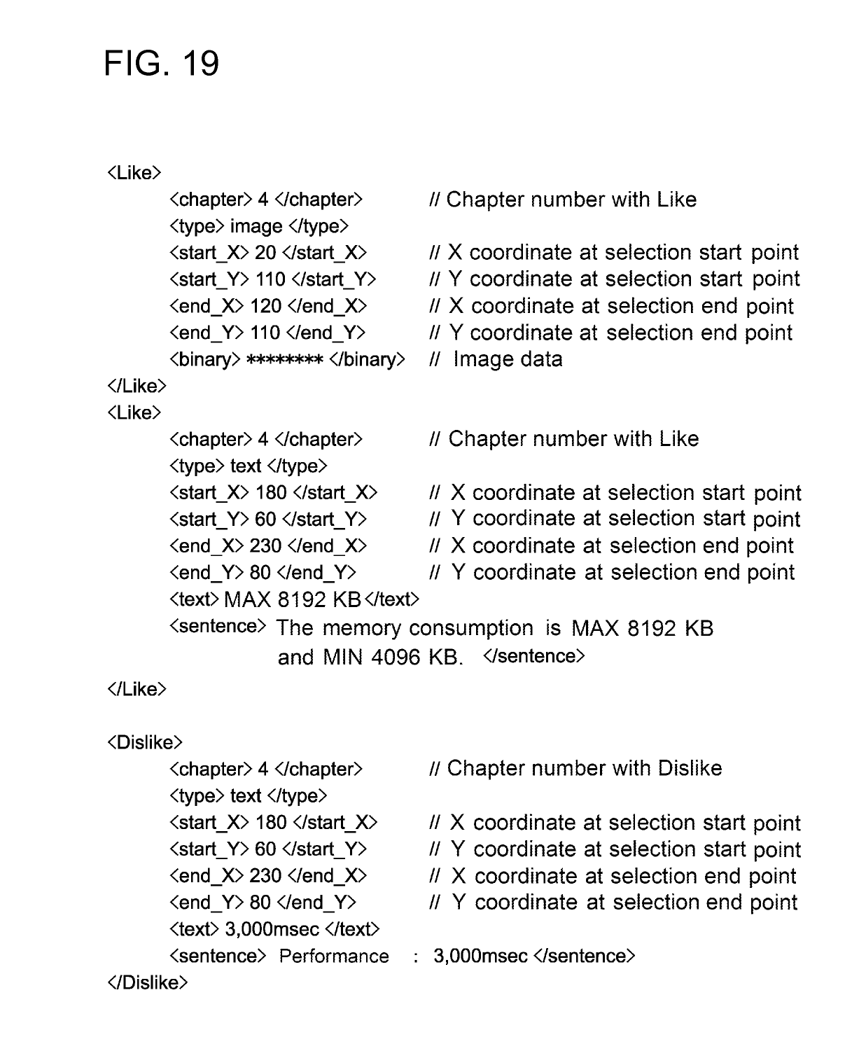

FIG. 19 collectively illustrates the exemplary metadata 17b created as evaluation results by the evaluators B, C, and D. The part of the Like attribute, which is illustrated at the top level in FIG. 19, indicates that the Like attribute is given to the specific part in the graph of Test4 by the evaluator D. The “image” indicative of image data is specified to the <type> tag.

The state where the evaluator gives the Like attribute or the Dislike attribute to the specific part specified by the evaluator in the document registered with the document processing server 1 or the image forming apparatus 20 is described with the concrete example.

### Example of Generated Summary

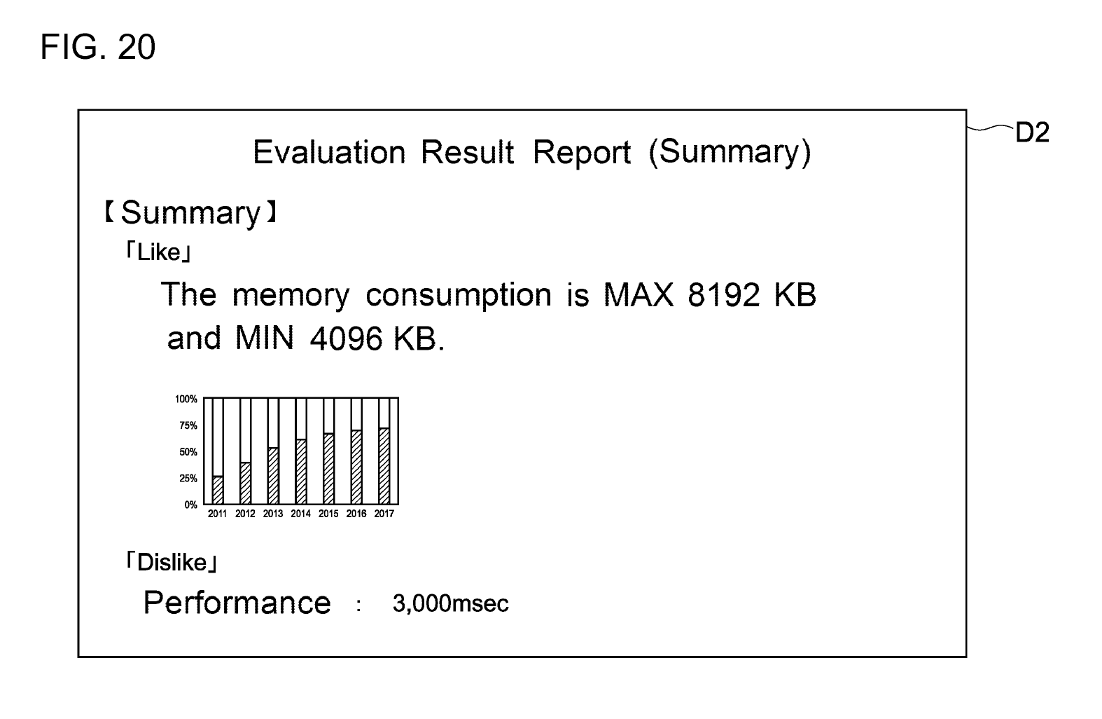

The following describes an exemplary summary generated based on the metadata collected in the above-described third phase. FIG. 20 illustrates an exemplary summary generated based on the collected metadata.

The summary D2, which is illustrated in FIG. 20, is generated based on the metadata 17b generated by giving the Like attribute or the Dislike attribute on the above-described document D by evaluator.

On the document D, the Like attributes are given to the “MAX 8192 KB” part and the Test4 graph, and the Dislike attribute is given to the “3,000 msec” part.

Accordingly, the summary D2 describes one sentence including “MAX 8192 KB,” “The memory consumption is MAX 8192 KB and MIN 4096 KB.” and the entire graph of Test4 in the “Like” item. The “Dislike” item describes one sentence including “3,000 msec,” “Performance: 3,000 msec.”

To summarize the document, extraction of not only the part selected by the evaluator but also a summarized, meaningful unit including the selected part (for example, one sentence or one paragraph) ensues easy understanding of the generated summary. The meaningful unit may be predetermined to be one sentence or one paragraph as one composition unit.

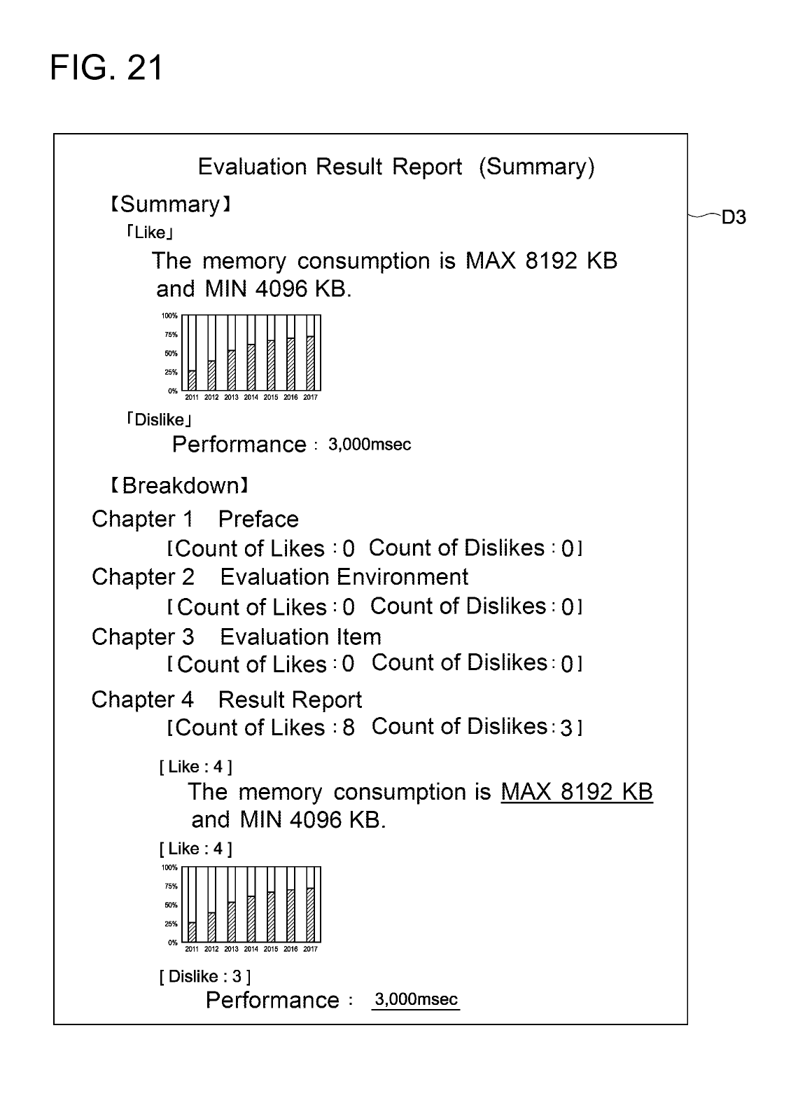

To the summary, a breakdown of where and how many Like attributes and Dislike attributes have been given to the part in the document may be described. FIG. 21 illustrates an exemplary summary D3 that describes breakdowns of given attributes in addition to the above-described summary D2.

Viewing the breakdowns illustrated in FIG. 21, it can be seen that the evaluator does not give the Like attribute or the Dislike attribute to the contents from the Chapter 1 to the Chapter 3 while the evaluator gives eight Like attributes and three Dislike attributes to the Chapter 4. It can be seen that among the eight Like attributes given to the Chapter 4, four of them are given to the “MAX 8192 KB” part while the remaining four Like attributes are given to the graph of Test4.

The exemplary summary generated based on the metadata collected in the above-described third phase is described above.

### Criteria for Employing as Summary

The following describes criteria of which part is employed as a summary among the parts to which the Like attribute and the Dislike attribute are given in the document.

As criteria for employment, for example, the Like attribute is given by equal to or more than the specific count of evaluators, the Dislike attribute is given by equal to or more than the specific count of evaluators, or a similar citation can be fixed.

The disclosure is premised that the part to which the evaluators give high evaluation and low evaluation and pay attention is the part that should be employed for summary. Accordingly, based on the count of given Like attributes and Dislike attributes, the disclosure determines whether to employ the specific part for the summary or not.

The criteria of which part is employed as a summary among the parts to which the Like attribute and the Dislike attribute are given in the document is described above.

### Criteria of Start of Creating Summary

The following describes criteria of a timing of creating the summary based on the collected metadata.

The timing of creating the summary is possibly as follows. For example, when the user explicitly instructs creation of the summary of a specific document, equal to or more than the specific count of evaluators evaluate one document, the Like attributes or the Dislike attributes given to one part exceeds a reference value, or a specific evaluation period has been expired.

The criteria of the timing of creating the summary based on the collected metadata are described above.

### Flow of Processing

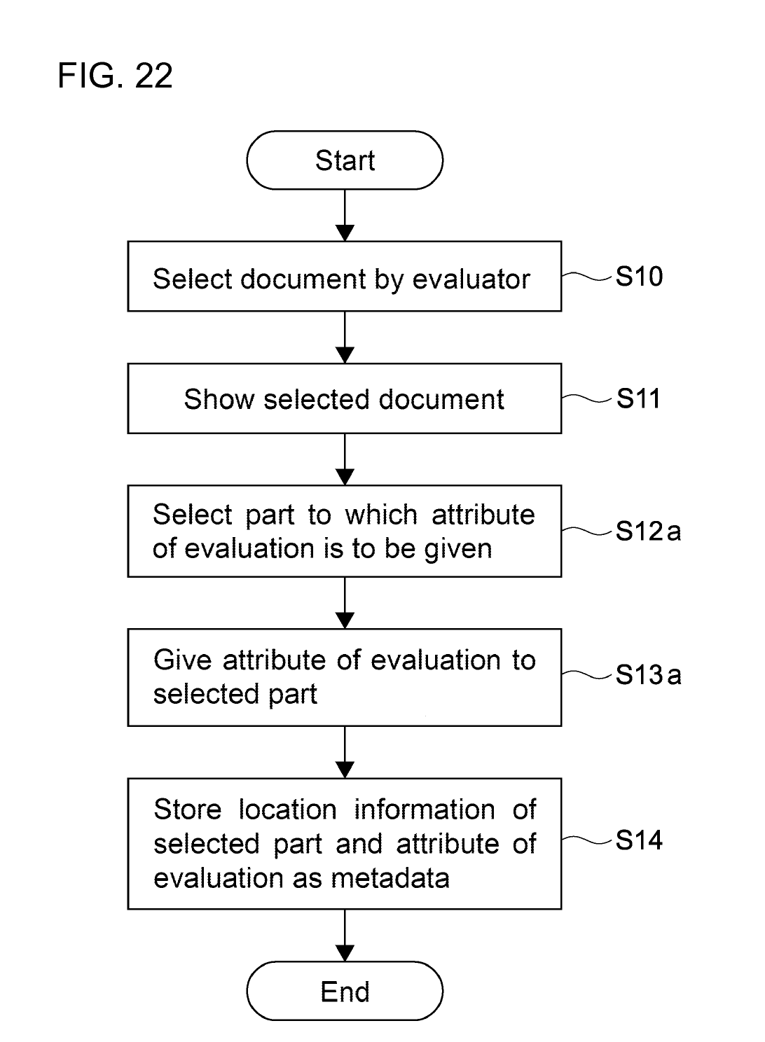

The following describes the flow of processing performed on the document processing server 1 and the image forming apparatus 20, which are the document processing devices. FIGS. 22 to 26 are flowcharts and sequence diagrams for describing the flow of processing performed by the document processing server 1 and image forming apparatus 20, which are the document processing devices.

The following description describes with the example of the image forming apparatus 20. The description is described divided from the first phase to the third phase.

### First Phase (Registration of Document)

The flow of processing of the first phase is identical to the flow of processing of the first phase in the first embodiment.

### Second Phase (Evaluation on Registered Document)

The flow of processing of the second phase is identical to the flow of processing of the second phase in the first embodiment except for the following points. FIG. 22 illustrates steps of processing at the second phase of evaluating the document registered with the image forming apparatus 20. The flowchart of FIG. 22 differs from the flowchart of FIG. 8 in that Step S12a and Step S13a are replaced by Step S12a and Step S13a.

Step S12a differs from the flow of processing in the second phase of the first embodiment in that the part to which the evaluator wants to give the attribute of low evaluation is selected in the shown document as well as the high evaluation.

Next, the evaluator presses the Like button or the Dislike button to the part selected at the previous step and gives the attribute of evaluation (Step S13a).

### Concrete Example of Second Phase

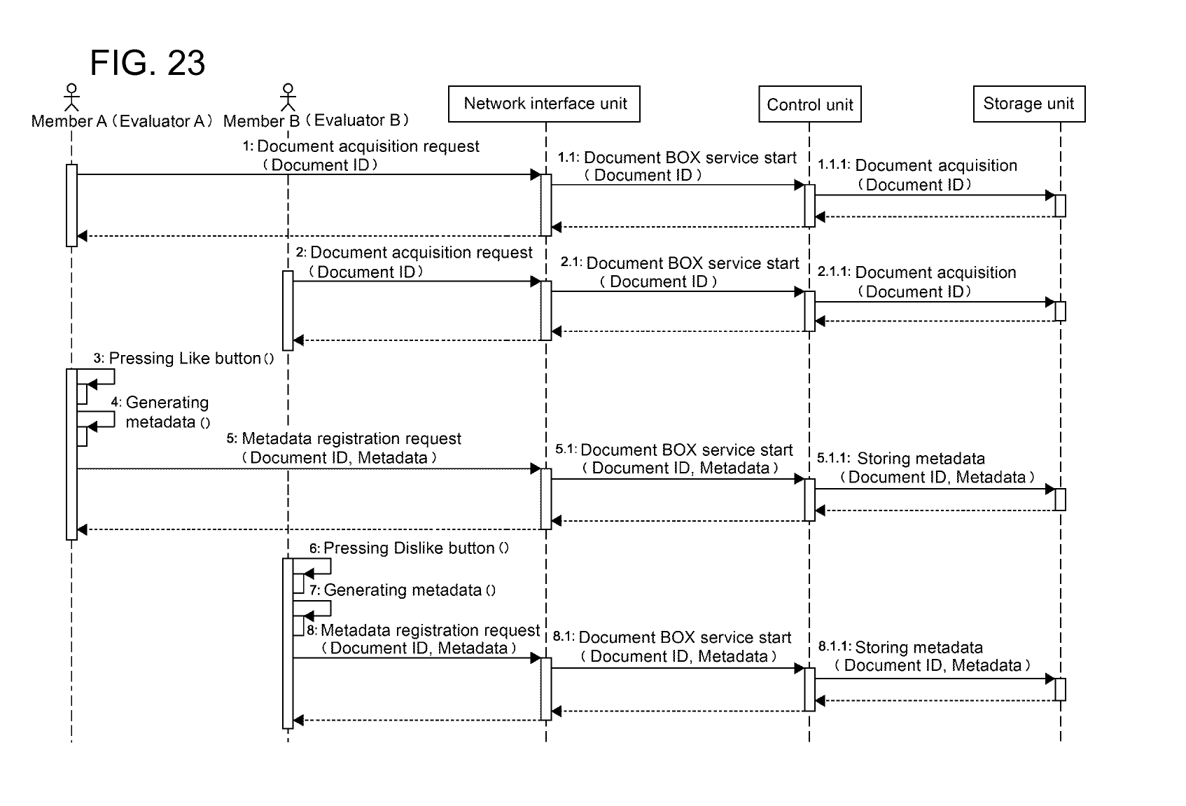

Next, the concrete example of processing that the two evaluators (evaluator A and evaluator B) evaluate the document with the image forming apparatus 20 is identical to the concrete example of the second phase in the first embodiment except for the following points. FIG. 23 illustrates a concrete example of processing where two evaluators (evaluator A and evaluator B) evaluate a document with the image forming apparatus 20 according to the second embodiment.

For the evaluator A, it is identical to the evaluator A for the concrete example of the second phase in the first embodiment. Next, the evaluator B also performs processing similar to the processing by the evaluator A except for pressing the Dislike button.

### Concrete Example of Collectively Performing First Phase and Second Phase

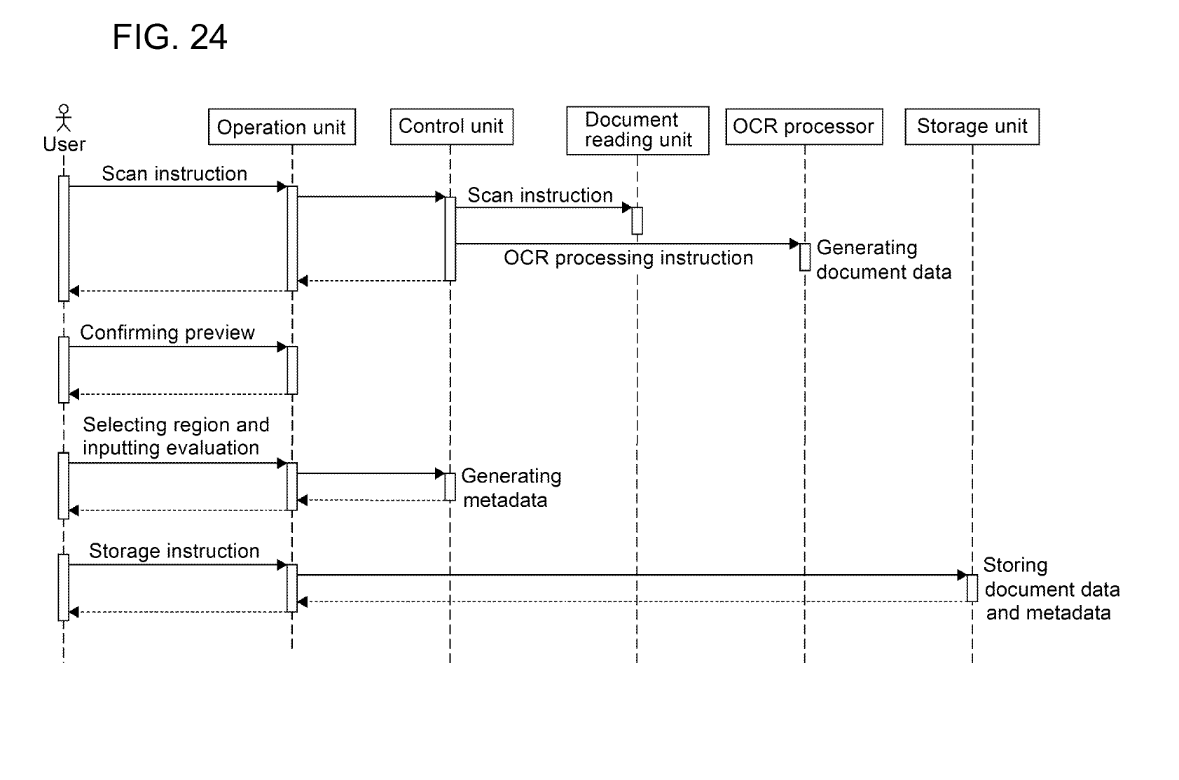

Next, the concrete example where the user who registers the document as the first phase also in charge of the evaluator for the second phase to collectively process the first phase and the second phase is identical to the concrete example in the first embodiment except for the following points. FIG. 24 illustrates a concrete example where a user who registers the document as the first phase also in charge of an evaluator for the second phase and collectively processes the first phase and the second phase in the second embodiment.

When the user as the evaluator selects the part to which the user wants to give the attribute of evaluation and gives the attribute to the selected part, the user gives the attribute of high evaluation or low evaluation.

### Third Phase (Utilization of Evaluation on Document as Metadata)

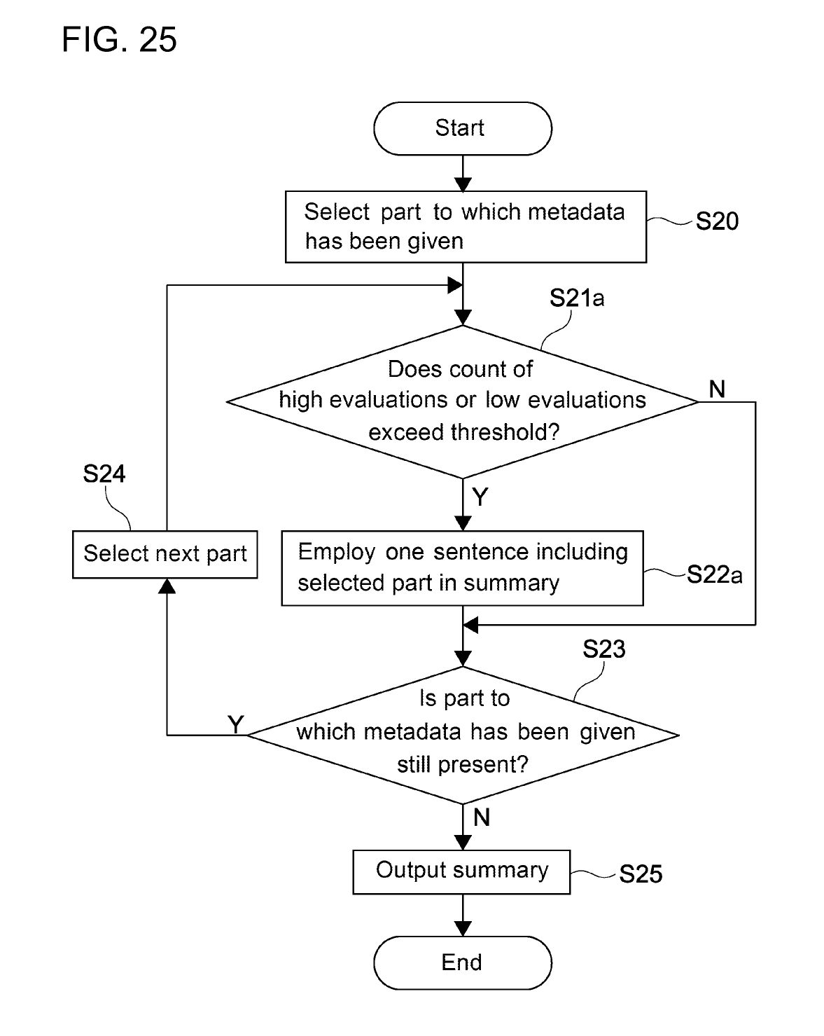

The following describes a flow of processing at the third phase where the summary of the document is created based on metadata regarding collected evaluations. FIG. 25 illustrates steps of processing at the third phase where the summary of the document is created based on the metadata regarding collected evaluations.

First, the control unit 21 searches the location information of the part to which the metadata 31b has been given in the document from which the summary is to be created. The control unit 21 selects one part among the parts to which the metadata 31b have been given based on the search result (Step S20).

Next, the control unit 21 determines whether the sum of high evaluations or the sum of low evaluations given to the selected part exceeds a specific threshold or not (Step S21a).

When the sum of high evaluations or the sum of low evaluations given to the selected part exceeds the specific threshold (Y at Step S21a), the control unit 21 employs and extracts a meaningful unit including the selected part (here, one sentence) for including the unit in the summary (Step S22a).

Next, the control unit 21 determines whether the part to which the metadata 31b has been given is still present or not (Step S23).

If the part to which the metadata 31b has been given is still present (Y at Step S23), the control unit 21 selects the part next to the part to which the metadata 31b has been given (Step S24) and returns to the processing at Step S21a.

When the part to which the metadata 31b has been given no longer exists (N at Step S23), the control unit 21 collectively outputs the summary from the extracted data (Step S25).

### Concrete Example of Third Phase

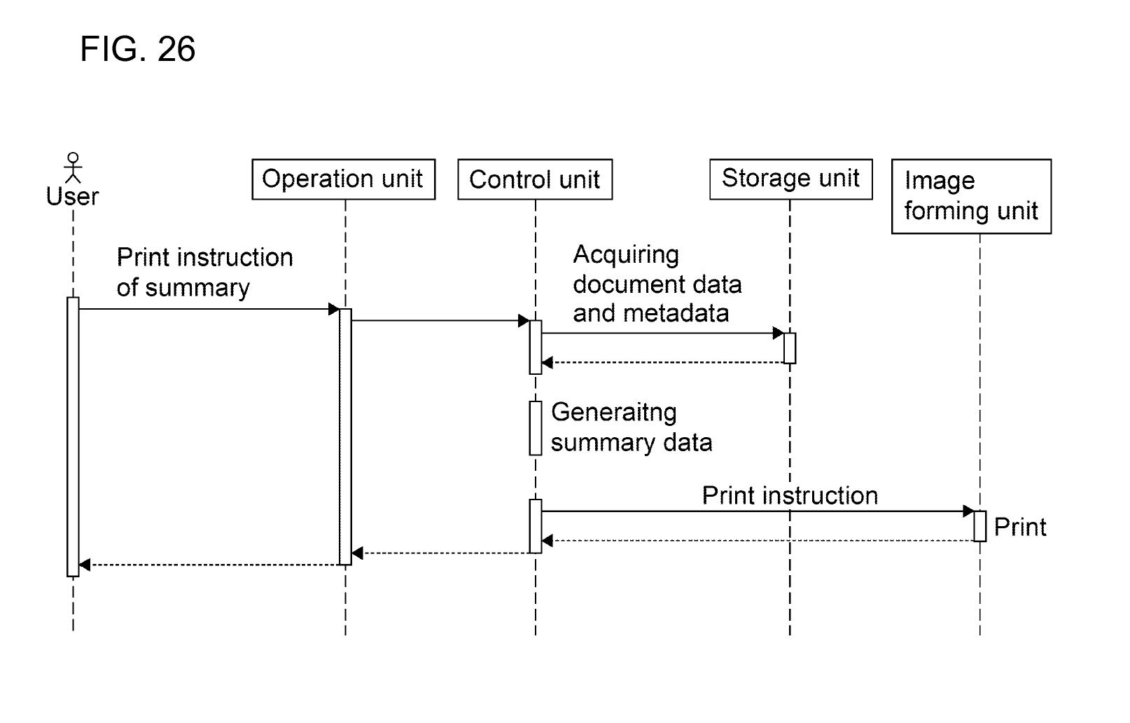

The following describes a concrete example until a user's instruction prints and outputs a summary at the third phase. FIG. 26 illustrates a concrete example until the user's instruction prints and outputs the summary at the third phase.

First, the user instructs the control unit 21 to print the summary of specific document via the operation unit 27 of the image forming apparatus 20.

Next, the control unit 21 acquires the document data 31a and the metadata 31b of the corresponding document from the storage unit 31s.

Next, the control unit 21 uses the acquired document data 31a and metadata 31b to create the summary. The summary may include the counts of the high evaluations and the low evaluations at each of the evaluated parts.

Next, the control unit 21 gives a print instruction to the image forming unit 26 to print and output the summary.

The flow of processing performed on the document processing server 1 and the image forming apparatus 20, which are the document processing devices, in the second embodiment is described above.

### Supplementary Note

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A document processing device comprising:
a storage circuit that stores document data including at least one of character data and image data;
an output circuit that outputs the stored document data;
a control circuit that causes the output circuit to output the stored document data to evaluate the document data by at least one evaluator; and
an input circuit that accepts location information and an evaluation result, the location information indicating a location of at least one evaluated part selected by the at least one evaluator who has evaluated the output document in the document data, the evaluation result being given to each of the evaluated parts; wherein
the control circuit further causes the storage circuit to store the location information and the evaluation result accepted by the input circuit, and
the control circuit extracts the evaluated part from the document data based on the stored location information.

2. The document processing device according to claim 1, wherein the control circuit extracts the image data including the evaluated part from the document data to share the document data based on the stored location information.

3. The document processing device according to claim 2, wherein the control circuit extracts the image data including the evaluated part from the document data to share the image data based on the evaluation result in addition to the location information.

4. The document processing device according to claim 3, wherein the control circuit extracts the image data including an evaluated part where a count of the given evaluation results exceeds a specific threshold among the evaluated parts.

5. The document processing device according to claim 1, wherein the control circuit uses the extracted data to create a summary.

6. The document processing device according to claim 5, wherein the control circuit extracts the evaluated part from the document data to create a summary based on the evaluation result in addition to the location information.

7. The document processing device according to claim 6, wherein the control circuit extracts an evaluated part where a count of the given evaluation results exceeds a specific threshold among the evaluated parts as the summary.

8. The document processing device according to claim 7, wherein when the control circuit extracts the evaluated part from the document data, the control circuit extracts one entire composition unit including the evaluated part.

9. The document processing device according to claim 8, wherein the control circuit causes the input circuit to accept any one of high evaluation and low evaluation as the evaluation result.

10. The document processing device according to claim 9, wherein the control circuit includes counts of the high evaluations and the low evaluations at each of the evaluated parts in the summary to be created.

11. A document processing method comprising:
storing document data including at least one of character data and image data in a storage circuit;
outputting the stored document data via an output circuit;
outputting the stored document data to the output circuit via a control circuit to evaluate the document data by at least one evaluator; and
accepting location information and an evaluation result via an input circuit, the location information indicating a location of at least one evaluated part selected by the at least one evaluator who has evaluated the output document in the document data, the evaluation result being given to each of the evaluated parts; wherein
the outputting via the control circuit includes
storing the location information and the evaluation result accepted via the control circuit, and
extracting the evaluated part from the document data based on the stored location information via the control circuit.

12. A non-transitory computer-readable recording medium storing a document processing program for controlling a document processing device, the document processing program causing the document processing device to function as:
a storage circuit that stores document data including at least one of character data and image data;
an output circuit that outputs the stored document data;
a control circuit that causes the output circuit to output the stored document data to evaluate the document data by at least one evaluator; and
an input circuit that accepts location information and an evaluation result, the location information indicating a location at least one evaluated part selected by the at least one evaluator who has evaluated the output document in the document data, the evaluation result being given to each of the evaluated parts; wherein
the control circuit further causes the storage circuit to store the location information and the evaluation result accepted by the input circuit, and
the control circuit extracts the evaluated part from the document data based on the stored location information.
